(19) United States
(12) Patent Application Publication
(10) Pub. No.: US 2025/0100211 A1
(43) Pub. Date: Mar. 27, 2025

(54) MANUFACTURING DEVICE FOR MANUFACTURING OBJECTS IN LAYERS

(71) Applicant: Technische Universität München, München (DE)

(72) Inventors: Tobias Abstreiter, Lengdorf (DE); Inola Kopic, München, DE (US); Peter Mayr, Markt Schwaben (DE); Leonhard Röpfl, Hausham (DE); Alexander Matschinski, München (DE)

(73) Assignee: Technische Universität München, München (DE)

(21) Appl. No.: 18/833,309

(22) PCT Filed: Jan. 31, 2023
(86) PCT No.: PCT/EP2023/052301

§ 371 Date: Jul. 25, 2024

(30) Foreign Application Priority Data
Feb. 1, 2022 (EP) 22154514.8

(51) Int. Cl. B29C 64/147; B22F 10/14; B29C 64/245; B29C 64/35; B33Y 10/00

(52) U.S. Cl. CPC B29C 64/147; B22F 10/14; B29C 64/245; B29C 64/35; B33Y 10/00

(57) ABSTRACT

A manufacturing device for manufacturing an object in layers includes at least one transfer platform with a transfer platform surface, at least one application unit configured to apply at least one treatment layer and at least one material layer which together form a pre-material layer of the object, to the transfer platform surface, wherein the pre-material layer extends at least in a first direction (x) and/or in a second direction (y), and a construction platform configured to receive at least the at least one material layer of the pre-material layer from the transfer platform so that the object is manufactured in layers on the construction platform in a third direction (z).

### CROSS-REFERENCE TO RELATED APPLICATIONS

This application is a US national stage filing under 35 U.S.C. §371 of International Application No. PCT/EP2023/052301, filed Jan. 31, 2023, which claims priority to European Patent Application No. 22154514.8, filed Feb. 1, 2022, each of which is incorporated herein by reference in its entirety.

### TECHNICAL FIELD

This disclosure relates to a manufacturing device that serves to manufacture objects in layers, as well as a method for manufacturing objects in layers. Such a manufacturing technique is also called additive manufacturing or 3D printing.

### BACKGROUND

Manufacturing devices that additively apply material to create a desired spatial geometry are known. In particular, powder bed processes for manufacturing metallic components have found their way into the industry. What all powder bed processes have in common is that the build-up material is in powder form and this is selectively bonded within a powder bed. This can be done conventionally by using beam sources (electron or laser beam) and selective melting of the powder. Binder jetting processes play a special role in powder bed processes, in which a green compact is first manufactured within the powder bed by applying a binding liquid, the so-called binder, and this is then conventionally refined into the final metal component by heat treatment (so-called de-binding and sintering). A decisive disadvantage of binder jetting is the fact that during de-binding and sintering, residues of the binder or its decomposition products often remain in the component, which act as foreign substances within the metal matrix and can therefore cause negative material properties. Furthermore, conventional binder jetting processes reach their limits in solid structures, as large wall thicknesses make de-binding difficult to achieve and result in reduced strength. Another disadvantage of these conventional processes is the shrinkage of the green compacts during sintering, which can amount to up to 20% of the original printed volume. This is accompanied by the formation of residual stresses and cracks, which in many cases can be equated with rejects.

It could therefore be helpful to provide a manufacturing device and a method for manufacturing objects in layers which, with a simple structure, enable the reliable, cost-effective and time-saving manufacture of objects in layers which can also be manufactured with large wall thicknesses and with low shrinkage by the method.

### SUMMARY

We thus provide a manufacturing device for manufacturing an object in layers, including at least one transfer platform with a transfer platform surface, at least one application unit configured to apply at least one treatment layer and at least one material layer, including granular and/or powdery material, which together form a pre-material layer of the object, to the transfer platform surface, wherein the pre-material layer extends in a first direction (x) and in a second direction (y), and a construction platform configured to receive at least the at least one material layer of the pre-material layer from the transfer platform so that the object is manufactured in layers on the construction platform in a third direction (z).

We also provide a method of manufacturing an object in layers, including the steps of: applying at least one treatment layer to at least one transfer platform by an application unit, wherein the treatment layer extends in a first direction (x) and in a second direction (y), applying at least one material layer, including granular and/or powdery material, to the transfer platform before or after application of the treatment layer, wherein the treatment layer and the material layer form a pre-material layer of the object, transferring at least the material layer of the pre-material layer from the transfer platform to a construction platform, along a third direction (z), and repeating the steps of applying the at least one treatment layer and the at least one material layer and of transferring, so that the object is manufactured on the construction platform in layers, in the third direction (z).

### BRIEF DESCRIPTION OF THE DRAWINGS

FIG. 1 is a schematic illustration of a manufacturing device according to an exemplary embodiment.

FIG. 2 is a detailed view of an application unit of the manufacturing device according to an exemplary embodiment.

FIG. 3 is a schematic detailed view of the manufacturing device according to an exemplary embodiment.

FIG. 4 is a schematic flow chart of a method according to an exemplary embodiment.

FIG. 5 is a schematic detailed view of a sequence of method steps of the method according to an exemplary embodiment.

FIG. 6 is a schematic detailed view of an embodiment of the manufacturing device according to an exemplary embodiment.

FIG. 7 is a schematic detailed view of a sequence of a method step of the method according to an exemplary embodiment.

FIG. 8 is a schematic detailed view of a configuration of the manufacturing device according to an exemplary embodiment.

FIG. 9 is a schematic detailed view of a configuration of the manufacturing device according to an exemplary embodiment.

FIG. 10 is a schematic detailed view of a configuration of the manufacturing device according to an exemplary embodiment.

FIG. 11 is a schematic detailed view of a configuration of the manufacturing device according to an exemplary embodiment.

FIG. 12 is a schematic detailed view of a configuration of the manufacturing device according to an exemplary embodiment.

FIG. 13 is a a schematic detailed view of a configuration of the manufacturing device according to an exemplary embodiment.

FIG. 14 is a schematic detailed view of a configuration of the manufacturing device according to an exemplary embodiment.

FIG. 15 is a schematic illustration of a manufacturing device according to an embodiment.

List of Reference Characters

| | |
|---|---|
| 1 | Manufacturing device |
| 2 | Transfer platform |
| 2A | Transfer platform surface |
| 3 | Application unit |
| 3A | Printing unit |
| 3B | Recoater |
| 4 | Construction platform |
| 4A | Construction platform surface |
| 5 | Foil element |
| 6 | Holding plate |
| 7 | Object |
| 8 | Layer |
| 8A | Treatment layer |
| 8B | Material layer |
| 9 | Object parts |
| 10 | Compressed air |
| 11 | Machining unit |
| 12 | Vibration generator |
| 13 | Spacer |
| 14 | Tappet |
| 15 | Transfer plate |
| 16 | Adjusting screw |
| 17 | Active actuator |
| 18 | Electromagnet |
| 19 | Heat source |
| 20 | Heat |
| 21 | Rotating device |
| 22 | Frame of the manufacturing device |
| 23 | Cleaning device |
| 24 | Fluid |
| 25 | Fiber application device |
| 26 | Fiber |
| 27 | Rollers |
| 28 | Storage container |
| 100 | Manufacturing a layer |
| 110 | Applying the treatment layer |
| 120 | Applying the material layer |
| 130 | Cleaning step |
| 140 | First heating step |
| 150 | Second heating step |
| 200 | Transferring the layer |
| 210 | Approaching |
| 220 | Pressing |
| 230 | Stripping |
| 300 | Fiber reinforcement |
| 310 | Fiber application |
| 320 | Third heating step |

### DETAILED DESCRIPTION

If physical states of materials, substances, bodies or objects are described herein, such as “in liquid form”, and no associated temperature specifications are given, a temperature of 20° C. is to be assumed, with the exception that another temperature or another temperature range can be derived from the context.

When “bottom” and “top” are mentioned herein, this describes spatial assignments, for example, of a device and/or a figure. “Bottom” is closer to the center of the earth than “top”. A “bottom” is closer to the center of the earth than a “top”.

When a “transfer platform” is mentioned herein, this refers to a structural element which preferably comprises at least one flat surface which is suitable for receiving or temporarily depositing at least one chemical element (layers explained below), in particular a starting material of the object to be manufactured. The surface can be smooth, rough, textured or of a different configuration.

When a “transfer platform surface” is mentioned herein, that surface of a “transfer platform” is meant which has properties which are suitable for the absorption and/or release of the at least one chemical element, in particular of the starting material of the object to be manufactured. A “transfer platform surface” may comprise a special material or a special material matrix, i.e. the material of the transfer platform surface can be different from the material of the other parts of the transfer platform, can be formed in a special surface structure, may comprise at least one special coating and/or may be equipped with further properties that are advantageous for the method and the device.

An “application unit” can be any type of arrangement which is configured to displace or transfer the at least one chemical element, in particular the starting material of the object to be manufactured, from a first position to a further position, in particular from a starting material supply to a transfer platform or to a transfer platform surface.

A “treatment layer” can be a chemical element or a medium that is suitable for exhibiting and/or exerting special properties compared to other elements or media. Such properties can be caused, for example, by a fixation and/or storage of elements or materials, by a physical and/or chemical influence on elements or materials, by an electrical influence on elements or materials and/or by other interactions of at least two elements and/or materials which are advantageous for the method and the device. Preferably, a chemical element or a medium of a “treatment layer” is at least partially present in liquid form at temperatures of 0° C. to 180° C., particularly preferably at temperatures of 10° C. to 120° C. or, for example, at temperatures up to 200° C., 250° C. or 300° C. A “treatment layer” or parts of a “treatment layer” preferably have a boiling temperature or a boiling range. A “treatment layer” may comprise at least one solvent. A “treatment layer” may comprise at least one solid in powder form, in fiber form, in platelet form or as nanoparticles. A “treatment layer” may comprise at least one polymer, which is preferably present in dissolved form. A “treatment layer” may also be referred to as a “treatment agent”, in particular prior to application to a transfer platform surface. A “treatment layer” can be created by applying several identical or different “treatment agents” to a transfer platform surface simultaneously or successively. “Treatment agents” can be heated before application to a transfer platform surface, preferably to a temperature of up to 250° C., particularly preferably to a temperature of up to 130° C., such as, for example, to a temperature of up to 110° C.

A “material layer” is preferably formed from at least one solid, i.e. from a material in a solid aggregate state, or comprises at least one such material. A “material layer” is preferably in the form of a granular medium. Such granular media can be powdery, rod-shaped, sheet-shaped or in other forms. They can have a size in the nanometer range or a size of up to one millimeter or more. Granular media of a “material layer” may comprise different materials, have a different size and shape and/or be provided with a surface coating. A “material layer” is particularly preferably in powder form and is formed from at least one metal, at least one polymer, at least one glass and/or at least one ceramic material.

A “pre-material layer” describes a combination of at least one “treatment layer” and at least one “material layer”. A combination of a “material layer” and an already partially volatilized and/or physically and/or chemically modified “treatment layer” also constitutes a “pre-material layer”. If the treatment layer is completely volatilized after a combination of the material layer with the treatment layer (pre-material layer), for example, before the latter is transferred, the remaining material layer is still referred to as the “pre-material layer”.

An “object” can be a part or a structure in any form or shape and be made of any material that can be manufactured using the method and/or device. Parts or areas of an entire component or assembly are also to be understood as an “object”. Alternatively, such a part of an “object” can also be referred to as an “object part”. In particular, an “object” is preferably formed at least in large parts from a metal or a polymer material or preferably comprises larger quantities of one of these.

When a “construction platform” is mentioned herein, a structural element is meant which preferably comprises at least one flat surface. A “construction platform” is suitable for holding or receiving material, in particular a material layer, which can be referred to in total as an object. The surface of a “construction platform” can be smooth, rough, textured or have a different design. A “construction platform” can be made of metal, ceramic material, plastic material, glass and/or combinations/mixtures thereof.

The desired effect is achieved by a manufacturing device for manufacturing objects in layers. The manufacturing device comprises at least one transfer platform with a transfer platform surface, and at least one application unit. The application unit is configured to apply at least one treatment layer and at least one material layer, which together form a pre-material layer of the object, to the transfer platform surface. In particular, the material layer comprises granular and/or powdery material. The pre-material layer applied to the transfer platform surface by the application unit extends in particular in a first direction and in a second direction. The treatment layer and/or the material layer can in particular be applied line by line or area by area. In particular, it is provided that the system, which comprises the application unit and transfer platform, comprises at least two degrees of freedom which allow relative movement of the transfer platform and application unit along the two directions. A conventional additive manufacturing method can thus be carried out particularly advantageously to produce the treatment layer and/or the material layer on the transfer platform surface.

The manufacturing device also comprises a construction platform. This platform is configured to receive at least the material layer of the pre-material layer from the transfer platform, so that the object is manufactured in layers on the construction platform in a third direction, in particular. The construction platform can be configured in particular for receiving the treatment layer and the material layer of the pre-material layer.

Advantageously, the first direction, the second direction and the third direction are perpendicular to each other.

In particular, the pre-material layer is applied to the transfer platform surface by the at least one application unit by applying at least one treatment layer and at least one material layer by a binder jetting process.

In particular, the application unit is configured to apply the treatment layer to the transfer platform surface according to a predeterminable pattern. This pattern essentially corresponds to the geometry or shape of the layer to be transferred, in particular the resulting layer of the object or an object part of the object on the construction platform. After the material layer has been applied by the application unit, the material layer is bonded to the treatment layer (on the transfer platform surface), wherein the pre-material layer has the predefined geometry and shape of the layer to be transferred. As will be explained below with reference to the manufacturing method, the treatment layer can be applied before or after the material layer is applied.

Preferably, the material layer is applied to essentially the entire surface of the transfer platform surface. The material layer adheres to the transfer platform surface only at those areas which correspond to parts of the applied pattern of the treatment layer. In other words, sections of the material layer that are not connected to the treatment layer do not adhere to the transfer platform surface. In the case where the material layer is applied before the treatment layer is applied, the material layer does not adhere to the transfer platform surface until it is bonded to the treatment layer or as soon as the pre-material layer is formed, i.e. after the treatment layer has been applied.

Advantageously, the transfer platform is heated to transfer the layer (treatment layer and/or material layer) from the transfer platform to the construction platform. According to a further embodiment, the transfer platform and the construction platform and/or the object parts located on the construction platform are heated to transfer the layer (treatment layer and/or material layer) from the transfer platform to the construction platform, the transfer platform preferably being heated more strongly (i.e. to a higher temperature) than the construction platform and/or the object parts located on the construction platform.

In some embodiments, at least the transfer platform and/or the construction platform may be configured to be movable in at least a third direction, preferably for transferring the pre-material layer or at least the material layer.

Advantageously, the construction platform is movable along the third direction, wherein movement of the transfer platform and/or the application unit along the third direction is preferably not provided. This simplifies the design of the manufacturing device.

In some embodiments, at least one transfer platform and/or at least one application unit can be movable along the third direction, preferably movable relative to one another. As a result, for example, several pre-material layers can be applied to the transfer platform surface one above the other and thus an object part formed from these several pre-material layers can be manufactured on the transfer platform surface. The degree of freedom in the third direction is preferably relatively small or short (in particular compared to the degree of freedom in the first and/or second direction), so that in particular only a few pre-material layers, preferably no more than ten pre-material layers, particularly preferably no more than five pre-material layers can be applied on top of each other on the transfer platform surface. In other words, according to this embodiment, it is not intended to produce the object as a whole on the transfer platform, but only a part of the object. Advantageously, two pre-material layers are formed on the transfer platform surface, further preferably three pre-material layers. Two or more pre-material layers can be configured in particular to generate a better material bond in a third direction (Z-direction) on the component, i.e. to achieve a higher strength, tensile strength, compressive strength, flexural strength and/or rigidity of the finished object. In some embodiments, the ductility and/or the damping capacity in relation to vibrations can be reduced, for example, by using different metals, plastic material and/or ceramic material. In some embodiments, the temperature and/or energy required for transfer to the construction platform surface and/or to objects already on the construction platform surface can be reduced when forming two or more pre-material layers, for example, by using different materials of the pre-material layers. For example, at least one pre-material layer can be formed at least in part from an alloy that melts at a lower temperature than another, such as at least one material that can be used for soldering or brazing.

Irrespective of whether movement of the transfer platform and/or the application unit along the third direction is not provided for or whether movement of the transfer platform and/or the application unit along the third direction is provided for to a preferably limited extent, as just described, the object is not assembled on the transfer platform in the sense of conventional additive manufacturing methods, but instead new pre-material layers are manufactured on the transfer platform and at least the material layers of the pre-material layers are assembled to form the object in a subsequent step on the construction platform. In particular, this makes it possible to dispense with support structures. In addition, manufacture can be carried out in parallel by producing several pre-material layers simultaneously or at different times on separate transfer platforms. This significantly reduces the manufacturing time for the object.

Furthermore, the possibility of targeted temperature control and process control is provided. For example, a temperature at least close to or equal to the melting temperature of the material used for production can be easily and reliably achieved and maintained. This allows strength and/or bonding between the individual layers to be controlled in a simple and reliable manner. The cooling of the material layer(s) and/or the object can thus also be controlled or regulated very precisely to specifically influence or change crystallization behavior, for example.

An application unit can generally be used for one or more transfer platforms. In particular, two application units can be used for one or more transfer platforms.

In some embodiments, two, three, four, five or six transfer platforms and/or application units may be used. In some embodiments, the manufacturing device may have more than two application units for each transfer platform, for example, three, four, five or six application units.

Preferably, the manufacturing device comprises one application unit for each transfer platform. Thus, in particular, a number of transfer platforms and application units are identical. In other words, each transfer platform is preferably assigned exactly one application unit. The application unit is configured to apply both at least one treatment layer and at least one material layer of the material, in particular in granular and/or powder form, to the transfer platform surface of the transfer platform assigned to it.

Preferably, the application unit comprises a piezo print head and/or a so-called recoater.

It is particularly advantageous if the manufacturing device comprises at least two application units for each transfer platform. In other words, at least two application units are preferably assigned to each transfer platform. It is particularly preferred if exactly two application units are assigned to each transfer platform. In other words, the number of application units is preferably twice the number of transfer platforms. Preferably, a first application unit per transfer platform comprises a piezo print head for applying the at least one treatment layer. Further preferably, a second application unit per transfer platform comprises a recoater for applying the at least one material layer.

Preferably, it is provided for the construction platform to comprise a construction platform surface. The construction platform is also configured to receive at least the material layer of the pre-material layer from the transfer platform on the construction platform surface or on object parts of the object already present on the construction platform surface. In particular, the object parts of the object on the construction platform surface represent object layers that have already been received and joined together, which were previously applied to the transfer platform and received from the construction platform surface. The steps of producing the pre-material layer and joining the pre-material layer with other layers to form an object part are therefore separate from each other. This simplifies the execution of the respective steps, as these can always be controlled according to the individual requirements, wherein interactions no longer play a major role and can therefore be virtually disregarded.

The transfer platform and the construction platform are each particularly advantageously configured in such a way that the adhesion of the layer to be transferred (i.e. the pre-material layer or the treatment layer or the material layer) and/or existing object parts of the object to the construction platform is higher than to the transfer platform.

This can preferably be achieved by a respective surface finish and/or by a respective coating and/or by a respective choice of material for the respective platforms. The coating can be polytetrafluoroethylene (PTFE) and/or perfluoro (ethylene propylene) (PFEP), for example. The transfer platform may preferably comprise ceramic material or be formed from ceramic material. The construction platform may preferably comprise a metal or be formed from metal. These examples of materials can be used in particular when metals are used as a component of the pre-material layer or the treatment layer or the material layer.

Different adhesion can also be achieved by applying different temperatures to the platforms. The different adhesion properties make it quick and easy to transfer the layer from the transfer platform to the construction platform.

In some embodiments, at the moment of transferring the pre-material layer from the transfer platform to the construction platform or at least at the moment of detachment of at least the material layer of the pre-material layer from the transfer platform due to a relative movement of the construction platform, the temperature of the construction platform and/or at least within the areas of an object located on the construction platform surface closest to a transfer platform surface is at least in places and/or partially higher than that of the transfer platform, preferably at least 10° C. higher, particularly preferably at least 30° C. higher and very particularly preferably at least 50° C. higher, such as, for example, at least 80° C. higher.

In some embodiments, at the moment of transferring the pre-material layer from the transfer platform to the construction platform or at least at the moment of detachment of at least the material layer of the pre-material layer from the transfer platform by a relative movement of the construction platform and/or at least within the areas of an object located on the construction platform surface closest to a transfer platform surface, the temperature of the construction platform is lower than that of the transfer platform at least in places and/or in part, preferably at least 25° C. lower, particularly preferably at least 50° C. lower and very particularly preferably at least 100° C. lower, such as at least 150° C. lower.

Advantageously, the construction platform surface is oriented essentially parallel to the transfer platform surface during the receiving of at least the material layer of the pre-material layer from the transfer platform. This makes it easy to transfer the layer. In particular, the two platform surfaces can be arranged directly opposite each other so that the layer to be transferred may have contact with the transfer platform surface as well as contact with the construction platform surface or with object parts arranged on the construction platform surface.

Preferably, the manufacturing device comprises at least one rotating device. The rotating device is configured to rotate the at least one transfer platform. In particular, one rotating device per transfer platform is provided. In some embodiments, all transfer platforms are jointly connected to a single rotating device, which rotates all transfer platforms simultaneously. In particular, the rotating device is configured to rotate the respective or all transfer platforms preferably about an axis substantially parallel to the first direction and/or about an axis substantially parallel to the second direction and/or about an axis substantially parallel to the third direction. By rotating the transfer platform by the rotating device, excess material of the material layer, which is not connected to the treatment layer, can be removed from the transfer platform surface.

By rotating the transfer platform by the rotating device, in particular those portions of the material layer that are not connected to and/or bound by the treatment layer and/or are not in contact with it, are removed. It is particularly preferred that the transfer platform is rotated about an axis essentially parallel to the first and/or second direction. In particular, the transfer platform can be rotated by an angle greater than 90°, preferably by 100°, particularly preferably by 100° to 180°. In other words, the transfer platform can particularly preferably be turned around so that the transfer platform surface pointing in a first spatial direction (for example, upwards) points in a second spatial direction (for example, downwards) opposite to the first spatial direction after turning. After the excess material of the material layer has fallen down, the rotating device rotates the transfer platform(s) back to the initial position. In a particular embodiment, the transfer platform can be rotated through 360° by the rotating device. In some embodiments, the rotating device can be rotated several times through certain angles, for example, back and forth, preferably in short times and/or at high speeds, to impart in this way a jogging or shaking off of excess material of the material layer.

In particular, the rotating device is configured to rotate the transfer platform(s) during the application of the treatment layer and/or the material layer. In particular, a movement of the application unit(s) is combined with a rotation of the transfer platform(s) to produce or apply at least one material layer and/or the predetermined pattern (of the treatment layer). In doing so, the at least one transfer platform is preferably rotated about the axis parallel to the third direction. Alternatively or additionally, the at least one transfer platform can preferably be rotated or inclined about the axis parallel to the first direction and/or about the axis parallel to the second direction.

Preferably, the manufacturing device comprises at least one cleaning device which is configured to remove excess material of the material layer from the at least one transfer platform and/or the construction platform by sucking in and/or blowing off a fluid. Preferably, the cleaning device is a blower device which sucks in and/or blows off gas and/or mist and/or steam. Alternatively or additionally, the fluid may be or comprise a solvent, which in particular does not correspond to the material of the treatment layer.

In some embodiments, the cleaning device may be equipped with at least one device for sucking-off excess material from the pre-material layer and/or vapor and/or mist from the treatment layer. Such a device may be, for example, a suction nozzle in fluid communication with a suction device, such as a turbine or a vacuum cleaner. In some embodiments, suction nozzles may be configured as flat nozzles, preferably in a wider basic shape, to suck-off as much excess material and/or treatment agent as possible from the transfer platform.

Additionally or alternatively, the cleaning device may be provided with at least one device for blowing off excess material from the pre-material layer and/or vapor and/or mist from the treatment layer. In some embodiments, a device for applying a gas stream or a protective gas stream and/or another fluid stream, such as a mist or particle stream or jet of a (protective) gas and/or a liquid and/or solid particles or powders may be provided as a cleaning device, optionally as a pre-cleaning device or as the first method step of a multi-stage cleaning device. Such a device may, for example, comprise a nozzle, preferably several nozzles. Such nozzles can be configured as round nozzles with preferably relatively small nozzle outlets, such as smaller than 2 mm or smaller than 1 mm, or can be configured as flat nozzles. Ring nozzles, preferably with the possibility of combining an internal suction device, can also be used. In some embodiments, a (protective) gas flow and/or a fluid flow can be tempered, preferably heated, such as to a temperature above 70° C., preferably above 100° C., and particularly preferably above 150° C., such as above 200° C.

In some embodiments, a combination of at least one device for blowing off and/or accelerating excess material and/or treatment agents of a pre-material layer can be combined with at least one device for sucking off and/or collecting at least one of such. Particularly preferably, the manufacturing device comprises a plurality of cleaning devices. In particular, the manufacturing device comprises a number of cleaning devices corresponding to the number of transfer platforms. Furthermore, the manufacturing device preferably comprises a single cleaning device which comprises a number of inlet nozzles and/or outlet nozzles corresponding to the number of transfer platforms. Particularly preferably, the manufacturing device comprises two cleaning devices, wherein each of the two cleaning devices in particular comprises a number of nozzles corresponding to the number of transfer platforms. One of the two cleaning devices is configured to blow-off a fluid and the second of the two cleaning devices is configured to suck-in a fluid. In particular, the first cleaning device or the outlet nozzles of the first cleaning device can be arranged along the third direction above the respective transfer platform. In particular, the second cleaning device or the inlet nozzles of the second cleaning device can then be arranged along the third direction below the respective transfer platform.

Preferably, the manufacturing device comprises at least one vibration generating device. The vibration generating device is configured to remove excess material of the material layer from the at least one transfer platform and/or the construction platform by sound, in particular ultrasound, and/or by vibrations.

In particular, the manufacturing device comprises one vibration generating device per transfer platform. Preferably, the manufacturing device comprises a single vibration generating device, which is configured to remove excess material of the material layer from all transfer platforms. Preferably, the manufacturing device comprises a further vibration generating device which is configured to remove excess material from the construction platform.

Preferably, the vibration generating device is an ultrasonic generating device and the ultrasonic generating device is configured to heat the construction platform and/or the transfer platform by ultrasound.

In certain embodiments, the material layer or a part of the material layer is prepared by a fluidized bed process prior to application. In one such embodiment, the material, which is preferably in granular, rod and/or powder form, is stored in a storage container connected to the application unit, in which the material is acted upon from below (i.e. starting from a base of the storage container) by a gas, an inert gas or air. Due to the whirling up of the material caused by the application, media in granular, rod and/or powder form behave similarly to liquids. The whirled-up material is then applied to the transfer platform by the application unit(s).

Preferably, the manufacturing device comprises at least one fiber application device. The fiber application device is configured to apply fibers at least partially on the pre-material layer, in particular the material layer of the pre-material layer, on the transfer platform and/or object parts of the object on the construction platform. Preferably, the manufacturing device comprises one fiber application device per transfer platform. Preferably, the manufacturing device comprises a further fiber application device for the construction platform. In some embodiments, the manufacturing device comprises two or more fiber application devices per transfer platform and/or within the manufacturing device.

Preferably, the fiber application device is, for example, a recoater with rotatably mounted rollers. The rollers rotating in the operating state of the fiber application device thereby accelerate fibers, in particular short fibers, in the direction of the transfer platform to apply fibers at least partially on the pre-material layer, in particular the material layer, and/or in the direction of the construction platform to apply fibers at least partially on object parts of the object on the construction platform. In some embodiments, at least one roller may be smooth or predominantly or at least partially smooth on its surface and/or at least one roller may be provided with predetermined surface profiles, such as in the form of threads and/or worm threads and/or at least approximately in the form of toothed shafts.

The fibers or short fibers are preferably carbon fibers, glass fibers, aramid fibers or natural fibers. The fibers preferably have a length of up to a few millimeters, such as up to 10 mm, preferably up to 7 mm, particularly preferably up to 4 mm, such as 0.5 mm to 4 mm or 0.8 mm to 2 mm. According to an alternative embodiment, the fibers preferably have a length of less than 1 mm, such as less than 0.8 mm, preferably less than 0.5 mm, such as 0.05 mm to 0.4 mm.

The aforementioned fibers provide the advantage that they can advantageously increase the bonding of the object parts of the object, in particular the layer(s) to be transferred with the already existing object parts of the object on the construction platform surface, in the first, second and/or third direction, particularly preferably in the third direction, i.e. for a cross-layer increase in material bonding. By the fiber application device, short fibers can be introduced in addition to fibers that are already present in the material layer before the short fibers are introduced.

As an alternative or in addition to the rollers of the fiber application device described above, the fiber application device is preferably configured to accelerate the short fibers in the direction of the transfer platform and/or the construction platform by a material flow. The material flow can, for example, be a fluid flow, in particular a gas, inert gas and/or air flow. In some embodiments, the accelerating material flow can be used to orient the fibers along the material flow. Thus, an application angle between a longitudinal axis of the fibers and the surface of the pre-material layer on the transfer platform and/or the object parts of the object on the construction platform can be adjusted, for example, to 10° to 90°, preferably approximately to 90°. Here and in the following, “approximately” means in particular a deviation by an angular range of +/−100, preferably +/−5°. For example, “approximately 90°” means an angular range between and including 80° and 110°, preferably between and including 85° and 95°. This ensures the deepest possible penetration of the fibers into the corresponding material.

Particularly preferably, the first fiber ends facing the corresponding material (the pre-material layer or the object parts of the object) and/or at least parts of the longitudinal side of the fibers penetrate at least 10 pm to 100 pm into the corresponding material or its surface according to their acceleration, speed, orientation and/or on the basis of material parameters, very particularly preferably at least 150 pm. For example, the fibers penetrate to 20 pm to 400 pm or 100 pm to 500 pm. In some embodiments, fibers can penetrate up to 300 pm, up to 600 pm, up to 1 mm, 2 mm or several millimeters into a surface depending on their acceleration and/or other parameters. Preferably, the second fiber ends facing away from the first fiber ends and/or at least parts of the exposed longitudinal sides of the fibers and/or other regions or geometries thereof which protrude from the pre-material layer or the material layer on the transfer platform are introduced into the object parts of the object already present on the construction platform surface when the pre-material layer or the material layer is transferred to the construction platform. Preferably, the aforementioned fiber ends are introduced into the object parts by interacting with predetermined set parameters such as temperature, concentration of the treatment agent residues, pressure and/or speed. The penetration behavior of the fibers into the pre-material layer or into the material layer as well as into the object parts of the object can be adjusted by controlling the temperature of the respective material (into which the fibers penetrate). Thus, a higher temperature of the pre-material layer, the material layer and/or the object parts of the object preferably leads to a deeper penetration of the fibers with otherwise identical or essentially identical process parameters. Alternatively or additionally, the fibers and/or a material flow can be tempered to accelerate the fibers. This can also have an effect on the penetration behavior of the fibers. Preferably, depending on the material used in the material layer, the fibers and/or the material stream have a temperature above 150° C., particularly preferably a temperature above 200° C., very particularly preferably above 250° C., such as 250° C. to 450° C., at least within the fiber application device.

Fibers that strike the surface of the pre-material layer on the transfer platform and/or the object parts of the object on the construction platform at a shallow angle, for example, between and including 0° and 45°, largely adhere to the corresponding surface depending on the temperatures or do not or hardly penetrate it. These fibers can then be removed from the corresponding surface by the cleaning device and/or by the vibration generating device.

In some embodiments, other particles or granular media such as powders, grains, platelets, nanoparticles or tubes such as carbon nanotubes (CNTs) may be used as an alternative to or in addition to the fibers or short fibers. In an alternative embodiment, a manufacturing device comprises at least one fiber application device, at least one transfer platform, at least one application unit for applying at least one layer of the object and at least one construction platform. The application unit applies the at least one layer of the object, in particular line by line, to a transfer platform surface of the transfer platform, wherein the layer extends in a first direction and in a second direction. The construction platform is configured to receive the layer from the transfer platform so that the object is manufactured in layers in a third direction. The at least one fiber application device is configured to apply fibers to the layer on the transfer platform surface and/or to object parts of the object already present on the construction platform surface.

The at least one application unit is preferably an extruder, which is configured in particular for extruding a thermoplastic material. In some embodiments, the application unit operates according to a so-called “Fused Filament Fabrication (FFF)” process (FFF process) and/or according to a so-called “Fused Granular Fabrication (FGF)” process.

In a particularly advantageous variant, the application unit can apply different materials to the transfer platform.

Advantageously, the manufacturing device according to the above embodiments comprises a plurality of transfer platforms, each transfer platform preferably being assigned at least one separate application unit.

This enables the object to be manufactured in parallel by allowing several pre-material layers to be manufactured independently of each other. In this case, the construction platform is configured to receive at least the material layer of the pre-material layer from the transfer platforms in a predeterminable sequence to produce the object. This means that even large and/or complex objects can be manufactured quickly. Furthermore, it is preferable that different application units are provided so that individual transfer platforms can be printed/applied with different materials. This means that layers of different materials can be applied to the transfer platforms, for example, by different material layers and/or different treatment layers. This makes it possible to influence the mechanical properties of the object to be manufactured, such as a specific mass distribution or a defined local stiffness. It is also possible to set defined capabilities in terms of heat conduction or electrical conductivity. Sensory and/or actuator functions can also be integrated easily and at low cost.

It is particularly advantageous if at least one application unit is configured to produce the layer on the transfer platform by the binder jetting process and at least one other application unit is configured to produce the layer on the same or another transfer platform by the FFF process (extruder or filament extruder) and/or FGF process (granulate extruder).

The ability to displace the construction platform to receive layers from the transfer platform or transfer platforms also makes it possible to accommodate additional components. In particular, this means that a stiffening element can be inserted into an object part that has already been manufactured, for example, by pressing it in. The inserted stiffening element can be concealed by subsequently receiving additional layers.

Advantageously, the manufacturing device may also comprise a plurality of construction platforms. In this way, for example, two or more objects and/or object parts can be manufactured in parallel or simultaneously. In particular in the case of a multi-material arrangement or hybrid material arrangement, it is possible, for example, to start by applying a layer of a first object part made of a first material on a first construction platform. If a further layer of another material is then to be applied to the first object part, a layer of the first material can be applied in parallel to a second object part on a second construction platform. This allows two or more objects or object parts to be manufactured quickly and efficiently, particularly in the case of multi-material arrangements or hybrid material arrangements.

Advantageously, the manufacturing device comprises at least one energy application device. The energy application device is configured to supply energy to the treatment layer and/or the material layer and/or the object parts of the object. Preferably, the energy supply device is configured to supply energy to the transfer platform(s) and/or the construction platform.

The energy application device is configured in particular for heating the treatment layer and/or the material layer and/or the object parts of the object. The energy application device can heat the aforementioned layers and/or object parts of the object directly and/or indirectly by heating the transfer platform(s) and/or the construction platform. The treatment layer and/or the material layer can be heated in particular before and/or after the application thereof. For this purpose, the energy application device is or comprises preferably at least one heating device.

In particular, the energy application device is configured to heat the treatment layer of the pre-material layer and, in particular, to evaporate and/or vaporize it. After evaporation and/or vaporization, essentially only the material layer remains on the transfer platform. This makes it possible to transfer only the material layer to the construction platform.

In particular, the energy application device is configured to plasticize and/or melt the material layer.

In particular, the manufacturing device comprises at least one energy application device for the construction platform and at least one energy application device for all transfer platforms or for each transfer platform. Advantageously, the energy application device, in particular each energy application device, is configured to apply energy to the transfer platform and/or the construction platform by induction and/or microwaves, in particular to heat it. The energy application device for the construction platform is preferably configured to apply energy directly to the object parts of the object already present on the construction platform surface, in particular to heat them, for example, by induction or microwaves. Alternatively or additionally, the energy application device for the construction platform can heat the construction platform directly, for example, by induction.

Advantageously, the energy application device, in particular each energy application device, is configured to apply energy to the transfer platform and/or the construction platform, in particular the layer(s) and/or the object parts of the object, by a direct current flow (direct current or alternating current), in particular to heat and/or weld them. This can be combined in particular with the aforementioned possibility of induction.

In particular, the energy application device is configured to heat the entire manufacturing device (global heating).

For high-melting powders or granules as the material of the material layer, the transfer platform has a high heat dissipation in certain embodiments and is formed at least in part from copper, for example. Preferably, ceramic material such as aluminum oxide, aluminum titanate, aluminum nitride, silicon carbide, dispersion ceramics or silicon aluminum oxide nitride or a combination of at least two of the above can also be used as the material for the transfer platform or for parts of the transfer platform.

Particularly preferably, the manufacturing device comprises a cooling device with which the transfer platform and/or the construction platform can be cooled. The cooling device can in particular be a gas cooling system and/or a cooling liquid cooling system. In particular, the transfer platform may comprise at least one heat sink, preferably on an underside opposite the transfer platform surface.

The manufacturing device preferably comprises at least one machining unit, which is provided for machining object parts of the object and/or an entire object applied to the construction platform and/or for at least one (pre)material layer formed on the transfer platform surface. The machining unit is preferably a milling unit, a grinding unit or a drilling unit. The machining unit enables the object or parts thereof to be machined in a partially finished state, so that even those areas of the finished object that are difficult or impossible to access can be machined. It is also particularly advantageous that machining can be carried out using the machining unit during periods of time in which a further layer to be transferred to the transfer platform is waiting to be completed.

In some embodiments, instead of or in addition to a machining unit, at least one cutting and/or punching unit may be used, such as an (oscillating) tangential knife, to process at least parts of layers such as a (pre)material layer and/or at least parts of objects and/or, for example, continuous fibers and/or fiber mats on at least one transfer platform and/or on at least one construction platform.

In particular, the machining unit is configured to chip fibers protruding from the object parts of the object, which have been inserted into the layers and/or directly into the object parts by the fiber application device.

The transfer platform comprises a foil element and a holding plate that holds the foil element. The foil element preferably forms the transfer platform surface. Instead of a foil element, a thin plate can also be used, such as a carbon plate or another, preferably fiber-reinforced plate with a thickness of less than or equal to 5 mm, preferably less than or equal to 2 mm, particularly preferably less than or equal to 1 mm and most preferably less than or equal to 0.5 mm, such as 0.1 mm to 0.3 mm. It is also preferably provided that the foil element or the thin plate can be lifted off the holding plate at least in certain areas to detach a layer applied thereto. This allows the layer to be peeled off the foil element or thin plate, which minimizes stress on the layer when it is detached from the transfer platform. This minimizes the risk of damage to the layer and thus reduces the reject rate. Particularly advantageous is that the foil element or the thin plate is in direct contact with the holding plate during the application of the material layer and the treatment layer to the transfer platform surface, so that the foil element or the thin plate acts as a transfer platform surface. To detach the pre-material layer, in particular after removing excess material from the material layer, from the transfer platform surface, the foil element or the thin plate can be lifted off the holding plate in certain areas so that the pre-material layer is peeled off the foil element or the thin plate, for example, starting from an edge of the pre-material layer. The foil element is preferably made of polyimide and can have different surface roughnesses and/or surface structures. The thin sheet is preferably formed from at least one polymer, is preferably reinforced with fibers or other materials and/or preferably has different surface roughnesses and/or surface structures.

In some embodiments, the transfer platform surface and/or the construction platform surface can be cleaned after at least one method step or after at least one transfer of at least one (pre-)material layer, for example, by at least one washing device, at least one grinding device, at least one polishing device and/or at least one blasting device. Advantageously, the at least one cleaning device can be used for this purpose.

Advantageously, the transfer platform and/or at least one removable foil or at least one removable (thin) plate has surface structures for preferably enlarging the transfer platform surface. These surface structures can in particular be pyramids, ridges, grooves or similar structures protruding from the surface and/or incorporated into the surface. If a layer is applied to these surface structures, the contours of the surface structures are also visible on the opposite side of the layer. Such a layer or (pre)material layer equipped with predetermined surface structures, for example, already on the construction platform surface or on an object part on the construction platform surface as a result of a previous method step (i.e. already transferred), can therefore be bonded particularly reliably to a further layer, (pre)material layer and/or intermediate layer (to the construction platform or object parts) when it is transferred. This in turn ensures optimum adhesion between successive layers and thus improved integrity of the object, especially in the direction of layer thickness.

This disclosure also relates to a method for manufacturing objects in layers. The method comprises the following steps:

Application of at least one treatment layer to at least one transfer platform by at least one application unit. In particular, the treatment layer extends in a first direction and in a second direction. Before or after the application of the at least one treatment layer, at least one material layer is applied to the transfer platform. The material layer comprises, in particular, granular and/or powdery and/or fibrous and/or lamellar material. By combining the treatment layer with the material layer, these form a pre-material layer of the object. Next, at least the material layer of the pre-material layer is transferred from the transfer platform to a construction platform, in particular along a third direction. In some embodiments, the treatment layer or at least parts and/or areas of the treatment layer can also be transferred to the construction platform. The steps of applying the at least one treatment layer and the at least one material layer and of transferring can be repeated, so that the object is manufactured on the construction platform in layers, in particular in the third direction. When repeating the transfer, the layer to be transferred during this repetition can be transferred to a construction platform surface of the construction platform (locations where no layer is yet present) and/or to object parts of the object which are already present or have been formed on the construction platform by previously transferring layer(s).

The layer applied first, i.e. either the treatment layer or the material layer, is applied to a transfer platform surface of the corresponding transfer platform. The subsequently applied layer is applied to the first applied layer and any uncovered sections of the transfer platform surface.

Preferably, the treatment layer, irrespective of whether it is applied to the transfer platform before or after the material layer, is applied to the transfer platform in accordance with a predeterminable pattern. This predeterminable pattern of the treatment layer corresponds and/or corresponds at least substantially to the dimensions and geometry of the layer of the object to be manufactured and is preferably provided and/or processed by at least one control unit. The layer of the object to be manufactured is particularly preferably provided in accordance with at least one parameter of the pre-material layer to be manufactured, as explained below.

Preferably, essentially the entire surface of the transfer platform and/or a removable surface element is exposed to the or at least one material layer.

In some embodiments, the material layer is applied to at least large parts of the transfer platform or optionally a removable surface element, for example, in a linear or planar manner, and in particular no predetermined pattern is treated at least to some extent according to the geometry of the current layer pattern (for example, the associated treatment layer).

In some embodiments, only areas and/or structures of the transfer platform or, optionally, of a detachable surface element, for example, in a linear and/or punctiform manner, are applied with at least one material layer, in particular according to a predetermined pattern and/or at least largely according to the templates and/or geometries of the current layer pattern (for example, the associated treatment layer).

The material of the material layer preferably comprises polymers and/or metals. In further embodiments, the material of the material layer may comprise or consist of ceramic material or glass. In some embodiments, the material for the material layer may comprise mixtures and/or combinations of the materials mentioned herein, in any possible mixture, combination and/or order.

Preferably, after the treatment layer and the material layer have been applied to the transfer platform, the excess material of the material layer that is not bonded to the treatment layer is removed. Preferably, the method for this includes a cleaning step after the application of the treatment layer and after the application of the material layer, in which excess material of the material layer is removed from the transfer platform. The cleaning step preferably comprises rotating the at least one transfer platform by the at least one rotating device and/or sucking in and/or blowing off a fluid by the at least one cleaning device and/or removing excess material of the material layer by sound and/or by vibration by the at least one vibration generating device.

In the case in which the cleaning step comprises the sucking-off and/or blowing off of a fluid, gases and/or vapors of the treatment layer, in particular of the evaporating and/or vaporizing treatment layer, are preferably sucked-off and/or blown-off, in particular in addition to or as an alternative to the sucked-off and/or blown-off material of the material layer.

The cleaning step is carried out in particular after the application of the treatment layer and the material layer (regardless of the order in which these two layers are applied) and before the material layer or the pre-material layer is transferred to the construction platform.

A “post-treatment step” is preferably to be understood as the finishing and/or temporary fixing of at least parts of at least one pre-treatment layer or at least one material layer. During a post-treatment step, for example, a pre-treatment layer or a material layer can be treated with at least one additional agent or treatment agent, for example, to achieve a material refinement on the subsequent object, such as the incorporation or application of alloys, plasticizers, fibers, dyes and/or nanomaterials. A post-treatment step can be the application of at least one agent or (additional) treatment agent which is suitable, per se or in combination with other elements, media and/or materials, for temporarily increasing the bonding of at least the material layer. A temporary increase in bonding is preferably understood to mean that the bonding energy is and remains increased at least until the pre-material layer or at least the material layer is completely transferred to the transfer platform or to an object part of an object present on the transfer platform surface and solidified. Such a post-treatment step is preferably carried out before the material layer is transferred.

The transfer of the material layer and the treatment layer or only the material layer (hereinafter referred to as “the layer to be transferred” or “the layer”) from the transfer platform to the construction platform preferably includes the following sub-steps: First, there is a relative approach of the transfer platform and the construction platform. In particular, this ensures that the layer is both in contact with the transfer platform and in contact with the construction platform, especially with parts of the object already present on the construction platform. The layer to be transferred can then be pressed on the transfer platform surface against the construction platform surface of the construction platform or against object parts of the object already present on the construction platform surface. Preferably, the pressing force is exerted on the layer by the construction platform. Pressing improves the adhesion of the layer to the construction platform surface and/or to the object parts of the object. Finally, the layer is detached from the transfer platform surface. The transfer platform surface is thus available for the application of a further pre-material layer.

When transferring the layer to be transferred to the construction platform, it is not necessary to apply a pressing force, especially not a high pressing force. As an alternative to pressing, the transfer can be carried out by simply bringing the layer to be transferred into contact with the construction platform surface or with the object parts of the object on the construction platform.

Particularly preferably, the method comprises a first energy application step before and/or during and/or after the application of the treatment layer and/or before and/or during and/or after the application of the material layer.

The first energy application step and/or the further energy application steps mentioned below can preferably be carried out by a heating device for applying thermal energy. Alternatively or additionally, the energy application can, for example, take place by radiation and/or induction and/or vibration and/or sound and/or by an electric current.

The pre-material layer is preferably heated, in particular to a temperature close to or equal to the evaporation temperature of the treatment agent of the treatment layer. Preferably, the pre-material layer is heated to a temperature of ±20° C. of the evaporation temperature of the treatment agent of the treatment layer. Such a heating step can be carried out continuously over time or in discontinuous time intervals. “Continuous in time” means that the energy application steps or heating steps are carried out with a temporal overlap.

Preferably, the treatment layer comprises a solvent as a treatment agent, such as water, in particular deionized or fully desalinated water (demineralized water). Preferably, the pre-material layer is heated to a temperature between and including 80° C. and 120° C., preferably between and including 90° C. and 110° C., particularly preferably to 100° C. In this way, the treatment layer evaporates or vaporizes essentially residue-free, so that only the material layer with the pattern of the treatment layer remains on the transfer platform surface.

In some embodiments, the first energy application step can impart/generate temperatures below 100° C. at least in large parts, preferably below 80° C., for example, in treatment layers that include at least components of esters, ketones and/or simple alcohols such as ethanol or isopropanol, with or without added water, such as azeotropic mixtures of at least two media or treatment agents in various embodiments, and/or in the processing of material layers with at least portions or entirely formed from at least one polymer.

In some embodiments, for example, in the processing of metals, ceramic material, glass, silicates and/or regolith, a treatment layer may preferably comprise, at least in part, at least one glycerol, a glycol such as triethylene glycol and/or a glycol ether such as butyl triglycol, wherein the first energy application step generates temperatures of 80° C. to 220° C., or 140° C. to 320° C., for example.

In some embodiments, in a first energy application step, preferably at least 50% by mass of the entire treatment layer or at least of one component or medium of the treatment layer is evaporated and/or vaporized, more preferably at least 70% by mass and most preferably at least 90% by mass, such as at least 97% by mass or (nearly) 100% by mass.

Preferably, the method comprises a second energy application step, in particular after the first energy application step, in which the pre-material layer is brought to a further increased temperature, which in particular should be lower than or equal to or greater than the melting temperature or the melting range of the material of the material layer.

In the second energy application step, the pre-material layer is preferably brought to a temperature which is equal to or greater than the melting temperature or the melting range of the material of the material layer.

For example, alloys or certain polymers have a melting range between solidus and liquidus temperature.

The second energy application step is preferably carried out continuously in time, i.e. overlapping in time, with the first energy application step. In other words, the first energy application step does not have to be completed before the second energy application step is started or carried out. Alternatively, the second energy application step can only be started or carried out after the first energy application step has ended, i.e. it can be carried out discontinuously with the first energy application step.

The aforementioned second energy application step can preferably be carried out in various ways and depends largely on the material selection of the material layer and/or the material selection of the transfer platform. If, for example, a high-performance polymer such as PEEK (polyether ether ketone), PEI (polyethyleneimine) and/or PPSII (polyphenylene sulfone) is used as the material of the material layer, the pre-material layer can be heated in the second energy application step, in particular to a temperature range between and including 150° C. to 350° C.

In some embodiments, preferably when processing polymers, the temperature achieved in the second energy application step is preferably below 500° C. and particularly preferably below 400° C., such as 80° C. to 350° C. or 140° C. to 300° C.

When using metals such as stainless steel, in particular as granular and/or powdered material of the material layer, the pre-material layer is preferably heated to a temperature of about 1500° C. or higher during the second energy application step.

In some embodiments, preferably when processing metals, ceramic material and/or glass, the pre-material layer is preferably heated to a temperature of at least 400° C., preferably at least 500° C. and particularly preferably at least 600° C. or higher during the second energy application step. It is particularly preferable if only the pre-material layer or the material layer is (actively) heated and not the transfer platform.

In some embodiments, at least during the second energy application step, not only the pre-material layer or the material layer is heated, but additionally at least parts or regions of the transfer platform and/or the transfer platform surface and/or a detachable surface element, preferably only at the locations or closer regions of the (pre)material layer, very preferably more pronounced or with more heat output when the temperatures of the (pre)material layer increase, and very preferably starting from a temperature of the (pre)material layer of about 500° C.

The first and/or second energy application step can, for example, be mediated by the introduction of thermal energy by microwave radiation. The microwave radiation can preferably be generated either via a vacuum transit time tube, a so-called magnetron, or via a laser in the microwave range, a MASER (microwave amplification by simulated emission of radiation). With the help of the magnetron, the radiation is emitted over a large area or directed at the pre-material layer. When using a MASER, the microwave radiation can be directed into the pre-material layer.

As an alternative or in addition to the use of microwave radiation, energy can be introduced by induction. For this purpose, the transfer platform is electrically conductive in particular. When energy is applied or heated by induction, an induction coil, in particular a flat coil, is preferably arranged close to the transfer platform. Alternatively or additionally, the induction coil can be arranged in such a way that the transfer platform is located within it. Furthermore, the manufacturing device, in particular the energy application device, can have additional switched active and passive coils to enable a targeted design of the alternating inductive field for the energy input by induction. This ensures a controlled energy input into the pre-material layer in particular.

Alternatively or additionally, the aforementioned energy, in particular thermal energy, can be introduced by alternating high-frequency electric fields as dielectric or capacitive heating. Alternatively or additionally, the aforementioned energy can be introduced by galvanic coupling through ohmic heating. It is particularly preferable if the entire heating and, in particular, melting process of the material layer takes place in a protective gas atmosphere to avoid oxidation or interaction with atmospheric gases. Alternatively or additionally, the aforementioned energy for heating and/or fusing the layer(s) in itself and/or with the object parts of the object already present on the construction platform can be brought about or promoted by a redox reaction.

The aforementioned energy application steps can be carried out in each or both cases after the application of the treatment layer and the material layer and before the transfer of at least the material layer of the pre-material layer to the construction platform. Alternatively or additionally, the energy application steps may each or both be performed after the transfer of the material layer and the treatment layer (pre-material layer) to the construction platform. In other words, for example, the treatment layer and the material layer can first be applied to the transfer platform, excess material from the material layer can be removed, the remaining pre-material layer can be transferred to the construction platform and then the treatment layer can be at least partially removed from the pre-material layer transferred to the construction platform by energy application. Furthermore, the transferred (pre)material layer can then be heated to a melting temperature as explained above.

The treatment layer does not have to be completely removed from the pre-material layer. Rather, an amount of treatment agent of the treatment layer can remain in the pre-material layer after the first energy application step, in particular to thereby keep the melting point of the material of the material layer low. This is preferably used when polymers are used as the material of the material layer. In particular, this ensures better adhesion of the material layer to the object parts of the object and/or the construction platform surface.

Preferably, the method comprises a fiber application step, in particular after the cleaning step, in which the pre-material layer and/or the material layer is at least partially applied with fibers, preferably short fibers. The fiber application step is carried out in particular by the at least one fiber application device.

Preferably, the fiber application step is carried out during or after the first and/or second energy application step. In particular, the fiber application step is carried out during and/or after heating of the pre-material layer in a temperature range of the melting temperature of the material of the material layer, for example, 50° C. below a melting point to 50° C. above such a melting point or 30° C. below to 30° C. above such a melting point, so that the pre-material layer has a reduced viscosity. As a result, the fibers are accelerated as described above by, for example, a recoater with rotating rollers and/or by a material flow in the direction of the pre-material layer on the transfer platform surface and/or the already existing object parts of the object on the construction platform surface. The orientation of the fibers is largely arbitrary. This means that a certain amount of fibers tends to hit the pre-material layer and/or the already existing object parts of the object at a steep angle (in particular between 45° and 90°) and penetrate at a steep angle depending on the fiber speed. Fibers that strike at an increasingly shallower angle will not or hardly penetrate into the pre-material layer or into the object parts of the object, but will essentially only remain by slightly adhering to the surface of the pre-material layer and/or the object parts of the object. The rotating rollers of the recoater, the material stream and/or the fibers can be heated using methods and devices known to those skilled in the art.

This type of fiber reinforcement process can be used in particular to achieve an almost isotropic orientation of fibers bonded in polymer.

Preferably, the aforementioned cleaning step can be carried out again after the fiber application step, so that fibers that are not or only insufficiently bound are removed from the surface of the pre-material layer and/or the object parts of the object.

It is particularly preferable if fibers are applied to both the last transferred layer (object part of the object) on the construction platform and the pre-material layer on the transfer platform surface. This results in fiber reinforcement between the boundaries of the individual layers of the object manufactured in this way. The ratio of fibers between the object part of the object and the layer to be transferred can be approximately 1:1. This means that approximately half of the fibers present in one layer of the object are inserted into the surface of the object part of the object on the construction platform and approximately the other half of these fibers are inserted into the layer to be transferred.

Preferably, the method comprises a third energy application step before and/or during the fiber application step, in which energy is supplied to the pre-material layer on the transfer platform and/or to the object parts of the object on the construction platform before and/or during the application of fibers. This preferably heats the pre-material layer on the transfer platform and/or the object parts of the object on the construction platform. The application of energy or the heating of the pre-material layer on the transfer platform and/or the object parts of the object on the construction platform preferably reduces the viscosity of the pre-material layer or the object parts of the object so that the fibers can penetrate deeper into them.

Alternatively or in addition to energy application, the viscosity of the pre-material layer and/or the object parts of the object can be reduced by solvents and/or pressure changes and/or by further physical and/or chemical measures or by a combination thereof. By heating the pre-material layer and the object parts of the object, which in particular are both applied with fibers, the fibers can be introduced from one of the two into the other of the two while the pre-material layer and the object parts of the object contact each other.

If, for example, PEEK is used as the material of the material layer and heated to the melting temperature range or to the melting temperature, the viscosity of this polymer material in the material layer decreases.

When processing PEI as the material of the material layer, on the other hand, a comparable effect can be achieved using the solvent DOM (dichloromethane). In some embodiments, such a solvent is preferably a component of the treatment layer and/or is additionally applied to the pre-material layer and/or to the object parts of the object prior to the fiber application step. Preferably, a proportion of the solvent DOM in the treatment layer is at least 10% of the treatment layer. When using a solvent to reduce the viscosity of the pre-material layer and/or the object parts of the object, the method may comprise an additional (quasi fourth) heating step after the fiber application step to evaporate the solvent.

When using a solvent to reduce the viscosity, the fibers can be mixed with this solvent or dissolved in it, wherein the corresponding surface of the layer and/or the object parts of the object is then exposed to the mixture of solvent and fibers.

In a particular embodiment, the fibers may preferably be heated immediately prior to and/or during the fiber application step, for example, by radiant energy such as microwave radiation or infrared radiation, and/or by induction and/or sound waves. A corresponding radiation source can also be used to orient or align the fibers. The use of an accelerating material flow can thus become superfluous. In addition, the radiation can also be used to readjust the orientation of the fibers after exposure and penetration into the respective surface. If thermal energy is also introduced into the fibers and thus into the polymer material in this way, the temperature or solvent concentration can be adjusted for further processing.

Particularly advantageously, the temperature of the pre-material layer before and/or during pressing corresponds at least to the plasticizing temperature and/or the melting temperature of the material of the material layer. In this way, an optimum hold/optimum bonding between successive layers is achieved. Advantageously, the temperature of the pre-material layer corresponds at least to the plasticizing temperature and/or the melting temperature of the material of the material layer preferably shortly before contacting or pressing, in particular at the beginning of pressing, wherein the temperature of the pre-material layer decreases during pressing, in particular due to contact with the construction platform and/or the object parts of the object.

Advantageously, the transfer platform surface and/or the construction platform surface is cooled during and/or after the step of detaching the pre-material layer from the transfer platform. This makes it easier to detach the material from the transfer platform.

In some embodiments, exactly one pre-material layer is manufactured on the transfer platform surface during the application steps. This means that each pre-material layer is manufactured individually and transferred to the construction platform. This ensures that all layers are connected to each other, as the individual layers are joined to form the finished object solely by transferring them from the transfer platform to the construction platform. The direct production of a layer on an existing layer (on the transfer platform) is therefore avoided.

To transfer the pre-material layer from the transfer platform to the construction platform, in particular for the relative approach of the transfer platform and the construction platform, the construction platform is preferably moved along the first direction and the second direction and/or the third direction. The transfer platform advantageously remains in a predefined position. In particular, movement of the transfer platform along the third direction is preferably not provided. The transfer platform can be moved either stationary or along the first direction or along the first and second directions, wherein a movement is carried out in particular only for applying the pre-material layer. The layer can particularly advantageously be applied in such a way that the transfer platform is moved along the first direction and the application unit(s) along the second direction or vice versa. In any case, it is preferably provided that the transfer platform remains at a predefined position during the transfer of the layer to the construction platform. Advantageously, in a case in which a plurality of transfer platforms is provided, all transfer platforms for transferring the respective layers can remain at the same predefined position, in particular with respect to the second direction.

Preferably, the treatment layer according to the above explanations comprises a solvent. Particularly preferably, the treatment layer comprises a solvent mixture, wherein, for example, a solvent with further additives such as dissolved polymers and/or nanoparticles and/or fibers is provided.

The treatment layer preferably comprises a medium which is in liquid form at room temperature, in particular at 20° C. The treatment layer may be or comprise water. Alternatively or additionally, the treatment layer comprises an alcohol and/or glycols such as ethylene glycol, dieethylene glycol, triethylene glycol, propylene glycol or polyethylene glycol and/or an ester and/or an ether and/or an acetal and/or an acid and/or a base and/or a buffer or is formed from at least one of these.

In some embodiments, the treatment layer is made of at least one solvent from the group of halogen-free and non-polar hydrocarbons and their derivatives and/or a solvent from the group of bio-based solvents, or comprises at least one of these.

In some embodiments, the treatment layer is made of or comprises at least one material which can activate or promote a chemical reaction, which can be a component of a chemical reaction or comprises a combination of these, in particular for a chemical reaction with the material layer.

In some embodiments, the treatment layer is or comprises an adhesive or at least one component of an adhesive. In some embodiments, the adhesive is formed from an epoxy resin, a polyester resin, a phenolic resin or an acrylic or comprises at least one of these. In particular, the treatment layer can be transferred together with the material layer to the construction platform or to the already existing object parts of the object.

In some embodiments, the treatment layer is formed from at least one solvent and at least one dissolved polymer. In certain embodiments, further substances may be dispersed in the treatment layer, which may preferably be in the form of solids. In some embodiments, dispersed or dissolved substances may be or comprise nanoparticles. In certain embodiments, materials introduced into the treatment layer may comprise or be formed from at least one of the following: Boron nitride nanotubes (BNNTs), carbonaceous nanoparticles, metal and semi-metal oxides, semiconductors, metals, metal sulfides. Nanoparticles can preferably be brought into contact with at least one electric field before the treatment layer is applied. In this way, nanoparticles can be directed after application to the transfer platform surface by applying an electric field, preferably in the vicinity of the transfer platform.

In some embodiments, the treatment layer may comprise water or an aqueous solution. For example, a mixture of water and glycol may be used as the treatment layer. Such a treatment layer can be exposed to microwaves after application to the transfer platform. Microwaves are well absorbed by water and can therefore at least promote rapid heating. In this way, accelerated melting can be achieved, preferably with polymers.

In some embodiments, the object or parts of the object on the construction platform can be applied with and/or infiltrated with the treatment layer before a new layer is transferred. Such a treatment layer may result in further functions in the object. Thus, in certain embodiments, substances dispersed in such a treatment layer, such as fibers or adhesion promoters, can be applied and/or introduced to the object and preferably to the last layer manufactured.

In some embodiments, when using an aqueous-based treatment layer, an increase in temperature by microwaves or other forms of energy can preferably be achieved immediately before and/or during the transfer of the new layer to be applied by such an exposure of the last layer.

In particular embodiments, such a treatment layer may use or comprise solvents which promote fusion of the layers, for example, by at least temporarily reducing the melting point of polymers used in the contact area with such solvents. Contacting, exposure and/or infiltration as just described can be carried out, for example, by dipping, spraying, printing or vapor deposition, in particular by the application unit(s).

All or some of the aforementioned heating steps can be carried out globally, i.e. heating the entire manufacturing device, or locally, i.e. heating only individual components of the manufacturing device. In addition to the melting temperature or the melting range of a material or a material layer, there are other process-relevant temperatures that can be of particular importance for the method and the device. For example, it may be particularly advantageous to heat at least one material or material layer to a temperature equal to or greater than the heat deflection temperature (HDT), the Vicat softening temperature, the glass transition temperature, the crystallization temperature or the recrystallization temperature during one or more of the aforementioned energy application steps or during one or more of the aforementioned heating steps.

In some embodiments, at least residual amounts of at least one treatment layer within at least one pre-material layer can reduce the melting temperature of the material layer, usually specifically and predetermined for combinations of certain treatment agents of the treatment layer and the at least one polymer, preferably depending on the concentration ratios of the treatment agent to the polymer. In some embodiments, the mass ratios of the concentrations of the treatment agent of at least one treatment layer to the polymer of at least one material layer, which is referred to herein as the “B-P ratio”, are at a time of the first energy application step, the second energy application step, the second energy application step, the second energy application step, and the second energy application step, of an application of fibers or short fibers and/or during the transfer of the pre-material layer to the construction platform surface or to object parts of an object present on the construction platform surface between 70/30 and 1/99, preferably between 50/50 and 5/95 and particularly preferably between 35/65 and 10/90, such as, for example, at least temporarily at 50/50, at 40/60, at 30/70, at 20/80, at 10/90, at 5/95 and/or at 3/97.

In addition to the aforementioned standard temperatures, there are other temperatures of materials and material layers which may be of significance at least for certain embodiments of the method and the device. In particular, a solvent softening temperature is defined. A solvent softening temperature describes the temperature at which a material (of a material layer) interspersed or infiltrated with at least one specific solvent, in particular at least one polymer material, has viscous or melt viscous and/or other technical properties which are at least strongly comparable with the heat deflection temperature (HDT) of the same material or the same material mixture, but which is lower by a temperature of up to 150° C., preferably up to 100° C. and particularly preferably up to 30° C. due to the solvent contained. The properties of a temperature-dependent change in solvent softening and the associated melting behavior of a material depend in particular on the type of solvent and/or solvent mixture and its concentration and/or distribution in the material or in the material layer. In other words, the application and/or introduction of solvents into materials can change or reduce their properties such as melting temperature, heat resistance, melt viscosity and other properties. The change in these properties depends in particular on the type of solvent or solvent mixture, its concentration in relation to the material or the amount of material and its homogeneous or inhomogeneous distribution in the material or in the material layer.

A “detachable surface element” is primarily used for support and/or attachment to transfer platforms and/or transfer platform surfaces and/or to construction platforms and/or construction platform surfaces, preferably for temporary attachment. A “detachable surface element” can be made in the form and shape of at least one foil, a thin, for example, bendable plate and/or a (solid) plate, a mat or fiber mat such as a glass fiber or carbon fiber mat and/or a three-dimensional (more complex) structure such as a semi-finished product, an at least prefabricated component and/or an at least partially fabricated object. A releasable surface element may be formed from any material or combination of elements and materials mentioned herein, in particular with reference to the transfer platform and/or the construction platform, and/or may have at least any surface design, surface shaping and/or surface coating disclosed herein. In particular, a releasable surface element should withstand the process temperatures caused by the process at least temporarily or permanently and preferably have low wear properties and/or preferably exhibit low coefficients of thermal expansion or thermal material expansions at least similar to the underlying platform. Preferably, a detachable surface element is provided with means for being able to be connected to the corresponding platform (surface) in a predetermined manner, preferably in a reproducible and/or automatable manner, such as, for example, by locking, pinning, engaging, pivoting, rotating and/or sliding.

A “material layer manipulation device” is preferably configured to remove excess powder or material from a material layer which does not correspond to the pre-material layer, i.e. which is not bound, fixed and/or bonded within a treatment agent layer. Any device suitable for performing or at least assisting such removal is to be understood as a “material layer manipulation device”. In some embodiments, a “material layer manipulation device” may at least in part comprise or consist of at least one cleaning device and/or perform and/or assume predetermined movements and/or orientations of at least portions, parts and/or machine elements of the manufacturing device to provide for and/or effect removal of excess material of a material layer not belonging to and/or corresponding to the pre-material layer. In some embodiments, a “material layer manipulation device” may be alternatively or additionally configured or equipped by an additional energy input, such as by sound waves, vibrations and/or oscillations.

In some embodiments, at least parts of the device are not moved within Cartesian coordinates and/or trajectories for predetermined distances. For example, delta, tripod or hexapod systems and/or rotation, swivel, arc and/or tilt mechanisms may be used as the moving device at least in parts or sections and/or in combination with each other and/or with Cartesian systems.

When method steps are mentioned herein, the device or the control device is configured in some embodiments to perform one, more or all of these method steps, in particular if these are steps that can be performed automatically, or to correspondingly address corresponding devices, which are preferably based by name on the designation of the respective method step (e.g. “determining” as a method step and “device for determining” for the device, etc.) and which may also be part of the device(s) or be connected thereto in signal connection. e.g. “detecting” as a method step and “device for detecting” for the device, etc.) and which may also be part of the device(s) or be connected thereto in signal connection.

When used herein to refer to programmed or configured, these terms may be interchangeable in some embodiments.

The control device can initiate the execution of all or substantially all method steps. The method can be carried out essentially or completely by the control device. It can be partially carried out by the control device, in particular those steps can be carried out by the control device which do not require or involve human intervention and/or provision. The control device can serve as only a control device, or also as a regulating or closed-loop control device.

The control device may be programmed to have or cause the method to be carried out in any embodiment disclosed herein, for example, by control commands to the components and/or actuators required for this purpose, in particular as disclosed herein. The control device may be in signal communication with the required components for this purpose or may be prepared for this purpose.

In some embodiments, a control system is configured to use the measurement data of at least one infrared camera and/or at least one infrared thermometer with the 3D data of a 3D scanner in programmable combinations to determine temperature data of at least one (pre)material layer as accurately as possible and to control the energy application devices according to the measured values.

In some embodiments, a controller is configured to use artificial intelligence (K1) in the control, in particular by using machine learning algorithms to model the processes of material heating, preferably metal heating and/or melting of metals, polymers, ceramic material and/or glass. The model is trained using data from the sensors and historical data and can predict the temperature of the material at a given time. The controller uses this prediction to adjust the heating system to improve the accuracy and efficiency of the device and/or method.

In some embodiments, a powder or granular media for forming a material layer is preferably formed at least in large parts or completely from at least one polymer, such as from at least one semi-crystalline polymer such as PEEK, polyethylene, polybutylene, polyisobutylene or PLA, and/or from at least one amorphous polymer such as ABS, ASA, PMMA and/or SAN. The polymers used can be standard plastic material, high-quality plastic material and/or high-performance plastic material. In some embodiments, thermosetting plastic material or elastomers can be used as powder or granular media, in others PTFE or silicone.

In some embodiments, a powder or granular media for forming a material layer is preferably formed at least in large parts or entirely from at least one metal, an amorphous metal, a noble metal, a refractory metal, a light metal, a heavy metal, a non-ferrous metal, a shape memory metal, a rare earth metal or a metal alloy, such as aluminum, AIMg3, AI99.5, AIM a heavy metal, a non-ferrous metal, a shape-memory metal, a rare earth metal or a metal alloy, such as aluminum, AIMg3, AI99.5, AIMgSilO, AI-AW7075, Ti6AI4V, a cast aluminum alloy, magnesium, a magnesium alloy, tin, zinc, bismuth, a bismuth-tin alloy, copper, a copper alloy, copper-tin, copper-zinc, brass, bronze, iron, steel, structural steel, heat-treatable steel, quality steel, case-hardening steel, low-carbon steel, tool steel, hardenable steel, austenitic stainless steel, ferritic stainless steel, martensitic stainless steel, 316L stainless steel, titanium, nickel, titanium/nickel alloy (nitinol), nickel-based alloys, chromium, palladium, molybdenum, tungsten, gold, silver and/or other metals or alloys with at least one of these metals.

In some embodiments, a powder or granular media for forming a material layer is preferably formed at least in large parts or entirely from at least one ceramic material such as aluminum oxide, aluminum nitride, silicon carbide, silicon nitride, zirconium oxide, mixed ceramic material, boron carbide or sapphire glass.

In some embodiments, a powder or granular media for forming a material layer is preferably formed at least in large parts or entirely from at least one glass, such as silicate glass, quartz glass, borosilicate glass, crown glass and/or flint glass. In some embodiments, glass or glasses can be manufactured with predetermined optical, thermal and/or strength values, for example, with relatively uniform or homogeneous properties or with gradients, for example, in layers. The combination of glass and polymers, for example, laminated glass, can also be manufactured with the manufacturing device and with the method. In some embodiments, glass or glasses with predetermined optical, thermal and/or strength values can be manufactured, for example, with relatively uniform or homogeneous properties or with gradients, for example, in layers. The combination of glass and polymers, for example, laminated glass, can also be manufactured with the manufacturing device and with the method.

In some embodiments, a powder or granular media for forming a material layer is preferably formed at least in large parts or entirely from regolith.

In some embodiments, a powder or granular media for forming a material layer is preferably formed at least in large part or entirely from at least one of a polymer, a metal, ceramic material, glass and/or regolith, which may be mixed together, in any combination that is technically useful.

Mixing and/or combining and/or fusing of materials for a material layer, for example, as a compound, blend or mixed material, can take place both before powder production or before processing into granular media, for example, by a powder mill, and/or by mixing powders or granular media from different starting materials with one another after pulverization and/or after processing into granular media, either outside and/or inside the manufacturing device and in some embodiments as part of the method.

In some embodiments, a transfer platform and/or a transfer platform surface and/or a construction platform and/or a construction platform surface and/or a detachable surface element is configured at least essentially as a flat plate, preferably formed at least partially and/or in proportions from at least one ceramic material and/or at least one refractory metal, to be able to withstand in this way preferably process temperatures and conditions above 500° C., particularly preferably above 800° C. and very particularly preferably above 1200° C., in particular over a longer period of time and/or over several or many thermal cycling cycles and without or at least without significant signs of wear.

In some embodiments, at least one material, a ceramic material, a metal, a refractory metal and/or a glass of a transfer platform and/or of a transfer platform surface and/or of a construction platform and/or of a construction platform surface and/or of a soluble surface element can be formed as aluminum oxide, aluminum nitride, aluminum titanite, silicon carbide, silicon nitride, zirconium oxide, mixed ceramic material, boron carbide, sapphire glass, boron nitride, yttrium oxide, borosilicate glass, quartz glass, natural stone, granite, tungsten, molybdenum, platinum, nickel, chromium, steel, spring steel, stainless steel, fiber matrix, CFRP, GFRP, high-temperature polymers, duoplastic resin and/or other materials.

In some embodiments, the at least one construction platform or construction platform surface and at least one transfer platform or transfer platform surface are at least approximately identical in their size, area, length, shape and/or geometric configuration at least within a first direction and/or within a second direction and/or these platform (surfaces) form at least approximately comparable or at least approximately identical properties and/or sizes in the shaping when viewed from at least a perspective third direction, preferably from opposite sides.

In some embodiments, a transfer platform and/or a construction platform comprises a heating device and/or an energy application device with at least 3000 watts of power, preferably with at least 5000 watts and particularly preferably with at least 10000 watts, such as with at least 15000 watts or with at least 20000 watts.

In some embodiments, the at least one energy application device of a transfer platform and/or a construction platform comprises a resistance heating device, which preferably comprises at least one graphite and one boron nitride, and is particularly preferably formed from a graphite core coated and/or sheathed at least largely with pyrolytic boron nitride (PBN) as a resistance heater.

In some embodiments, the at least one energy application device is configured as an induction heater, preferably by a high-frequency generator, to be able to heat powders or granular media on the transfer platform directly in this way, i.e. at least primarily without or at least without a significant and/or additional energy input into the transfer platform and/or into the transfer platform surface carried out by the latter.

In some embodiments, the material thickness of a transfer platform is at least comparable to that of a construction platform.

In some embodiments, the material thickness of a transfer platform and/or a construction platform is predominantly or at least over large areas at least 8 mm, preferably at least 14 mm and most preferably at least 18 mm.

In some embodiments, a transfer platform and/or a construction platform is round in shape at least at the base and/or is configured as a disk or ring, for example, with a diameter and/or circumference of at least 100 mm, of at least 400 mm or of at least 800 mm.

In some embodiments, a transfer platform is preferably at least partially configured as a disk or ring, with an application unit being arranged in such a way that it can only ever treat segments of the circle or ring within each method step of applying the treatment layer and/or the material layer. With a manufacturing device with at least one at least partially circular or ring-shaped transfer platform, at least the method steps of treatment agent layer and material layer discharge, material layer manipulation, energy application to the (pre)material layer and transfer to at least one construction platform can be carried out in this way in a circular manner, preferably within one revolution of the transfer platform. In other words, preferably with each revolution of such an at least partially circular and/or annular transfer platform, at least one pre-material layer can be created and transferred to the construction platform, preferably in conjunction with at least a first and a second heat input. A transfer platform, which is at least partially configured as a disk or ring, rotates about an at least largely central axis of rotation, which is at least approximately perpendicular to the transfer platform surface, preferably at least predominantly in only one direction of rotation, particularly preferably not continuously, but with pauses and/or at least significant changes in the angular velocities, and preferably requires at least 20 seconds, preferably at least 40 seconds and particularly preferably at least 60 seconds for a complete rotation.

In some embodiments, a transfer platform and/or a construction platform has length dimensions in a first direction and in a second direction of at most 400 mm each.

In some embodiments, a device for guiding protective gas is preferably configured and/or configured to at least largely prevent oxidation of at least one material layer, such as metals or metal powders, on at least one transfer platform or at least one construction platform.

In some embodiments, a device for guiding protective gas is arranged at least in the vicinity of at least one transfer platform and/or a transfer platform surface and/or can be moved together (equally) with the latter at least within a movement device and/or these are configured to carry out at least one or recurring relative movement(s) during the various method steps and/or during the progressive layer build-up of the object.

In some embodiments, a device for guiding protective gas is arranged at least in the immediate vicinity of at least one construction platform and/or construction platform surface and/or can be moved jointly (equally) with the latter within a movement device and/or these are configured to perform at least one relative movement during the various method steps and/or during the progressive layer build-up of the object, preferably as a function of the progressive layer build-up of the object, in this way to preferably provide a protective gas flow on or around the at least one object part of an object that is at least approximately comparable across the layers, particularly preferably approximately at the level of the object parts currently closest to the construction platform (viewed within a third direction).

In some embodiments, a device for guiding protective gas is configured at least in part as an elongate, preferably at least partially straight and/or tubular machine element, and is configured to apply a fluid flow to at least one transfer platform (surface) and/or at least one construction platform (surface) by several or many bores or holes arranged laterally with respect to the longitudinal direction, preferably at least within a first and/or second direction as uniformly as possible and/or acting and particularly preferably with an at least predominantly laminar flow of protective gas. A shielding gas can also be configured as a process gas, so that a device for guiding shielding gas then represents a device for guiding process gas.

In some embodiments, the manufacturing device is equipped with a condensation device and/or a suction device for collecting and/or recovering evaporated and/or vaporized treatment agent layers.

In some embodiments, in particular at least 25% by mass of a treatment layer or at least the volatile solvent components of a treatment layer are evaporated and/or vaporized by a first heating step, preferably at least 50% by mass, more preferably at least 75% by mass and most preferably at least 90% by mass, such as at least 95% by mass or at least 99% by mass.

In some embodiments, the at least one energy application device for a transfer platform is configured such that the entire or at least almost the entire transfer platform is heated as uniformly as possible.

In some embodiments, the at least one energy application device for a transfer platform is configured such that all pre-material layers or at least all material layers on a transfer platform are heated simultaneously, preferably as uniformly as possible.

In some embodiments, a first and a second heating step and/or energy input is carried out within two directly successive method steps, in particular without an intervening cleaning step of a cleaning device and/or a device for material layer manipulation.

In some embodiments, a movement device is configured to move at least one transfer platform and/or a construction platform and/or a application unit in at least one direction of movement.

In some embodiments, a controller is configured to controllably execute at least one movement of the at least one transfer platform and/or the at least one construction platform and/or the at least one application unit in response to at least one parameter associated with the pre-material layer and/or at least the material layer in the speed and/or in the movement sequences. Preferably, the at least one parameter comprises a material of the pre-material layer, a desired surface condition of the pre-material layer, and/or a geometric property of the pre-material layer including particle size, particle distribution, density, volume, dimension and/or complexity of the pre-material layer.

Preferably, the at least one parameter is at least one temperature of the transfer platform surface, the material layer, the pre-material layer, the construction platform surface and/or the surface of an object located on the construction platform.

Preferably, the at least one parameter is measured by an infrared thermometer and/or by an infrared camera.

Preferably, the at least one parameter is at least one comparison value of the height of the object on the construction platform with the target height of the digital twin.

In some embodiments, the device is provided with a compaction module, wherein a compaction module is preferably arranged downstream of at least one device for printing at least one treatment layer and/or downstream of at least one binder printer.

In some embodiments, an application unit for at least one material layer within the same device can comprise at least one compaction device and/or a compaction module, to apply at least one material for a material layer onto a transfer platform, in particular at least almost simultaneously and/or preferably as one unit or one device and/or within one method step, and to compact it (simultaneously), either to predetermined values and/or ranges for a compaction predetermined by the control system or alternatively to non-predetermined and/or non-predeterminable values and/or ranges, wherein the at least one application unit for at least one material layer and the at least one compaction device or the at least one compaction module are in particular not separated from each other by any direction of movement of a transfer plate and/or a carrier substrate and/or they do not have any clearly definable space/time relationships to each other, e.g. no relative indications such as “upstream” or “downstream”. Preferably, a device with the combination of an application unit for at least one material layer and a compaction device for at least one material layer can be configured such that at least one roller-shaped machine element is arranged in the immediate or at least nearer region of the transfer platform surface and/or a detachable surface element, which is responsible both for conveying and thus applying at least one material of a material layer and at the same time can ensure compaction of at least the material layer.

In some embodiments, a first energy application step is performed only after a material layer manipulation step.

In some embodiments, a printer or print head for a treatment agent layer and/or a binder printer is not or at least not substantially arranged in a direction of movement of a compacting unit and/or a device for compacting at least one material layer.

In some embodiments, an application unit for a treatment layer is configured by a controller to apply predetermined patterns for the successive layers of an object or an object part in the form of isolated fluid drops (drop on demand) or by a continuous fluid flow onto at least one transfer platform, for example, by at least one piezo print head, by at least one electromagnetic print head, by at least one pneumatic print head, by at least one binder print head, by at least one progressive cavity extruder, by at least one piston extruder and/or by at least one volumetric material extruder with an elastic stator based on the operating principle of a linear peristaltic pump.

In some embodiments, the manufacturing device and/or the at least one transfer platform and/or the at least one construction platform after heating, plasticizing, liquefying, melting and/or fixing of at least parts of at least one material layer and/or after a first heating step and/or after a second heating step and/or after optionally further heating steps, performs no or at least virtually no more movement, preferably no linear and/or Cartesian movement and/or no rotational movement and/or at least no movement in a first and/or second direction, wherein small or very small movements, for example, for fine adjustment and/or for correcting the orientation of the platforms, may be excluded therefrom.

In some embodiments, a releasable surface element can be used only once on at least one transfer platform and/or at least one construction platform, in particular only for a transfer of at least one material layer and/or a treatment layer. In some embodiments, at least one intermediate layer can be transferred to the construction platform or to the surface of an object part already present on the construction platform surface, such as a polymer layer comprising at least one polymer.

In some embodiments, only one intermediate layer is formed between at least two material layers or pre-material layers.

In some embodiments, several intermediate layers are formed between at least two material layers or pre-material layers.

In some embodiments, at least one intermediate layer is configured as a solder or adhesive layer, preferably with at least one soft or hard solder or with at least one 1 K epoxy adhesive, a 2K epoxy adhesive, a PU adhesive, an acrylate, a UV adhesive or a hot-melt adhesive.

In some embodiments, a detachable surface element can be used several times on at least one transfer platform and/or at least one construction platform, in particular for the transfer of many material layers, pre-material layers and/or treatment layers, for example, at least 10 times, preferably at least 100 times and particularly preferably at least 500 times, to be able to produce at least one entire object with a detachable surface element in this way in a particularly preferred manner.

In some embodiments, the temperature curves of a transfer platform surface and/or a (pre-)material layer are recorded and/or measured with an infrared thermometer or with an infrared camera and forwarded to a control system.

In some embodiments, an infrared camera or an infrared thermometer is equipped with at least one optical filter such as an infrared filter, for example, to filter a fading of the images, for example, by a superimposed thermal radiation from a resistance heater, and in this way to be able to primarily and predominantly record and measure the temperatures and temperature curves of the (pre-)material layer.

In some embodiments, the time during a first energy application step is up to 15 minutes, preferably up to 8 minutes and particularly preferably less than 4 minutes, such as 3 seconds to 180 seconds or 30 seconds to 300 seconds.

In some embodiments, the time during a second energy application step is up to 15 minutes, preferably up to 5 minutes and particularly preferably less than 3 minutes, such as 3 seconds to 120 seconds or 15 seconds to 300 seconds.

In some embodiments, the (temperature) holding time during which the (pre-)material layer is in contact with the transfer platform surface or a detachable surface element and simultaneously with the construction platform surface or with object parts of an object already located on the construction platform surface, or at least no further than 0.5 mm apart in each case, is up to 5 minutes, preferably up to 2 minutes and particularly preferably up to 30 seconds, such as 0.1 seconds to 5 seconds or 1 second to 20 seconds.

In some embodiments, the cooling time during which the (pre-)material layer is in contact with the transfer platform surface or a detachable surface element and simultaneously with the construction platform surface or with object parts of an object already located on the construction platform surface, or at least at a distance of no more than 0.5 mm therefrom, is up to 10 minutes, preferably up to 5 minutes and particularly preferably up to 3 minutes, such as 5 seconds to 120 seconds or 30 seconds to 180 seconds. A cooling phase with a cooling time is started or initiated after either the energy application device remains switched off (for at least 10 seconds) and/or if the temperature falls below the temperature of the highest target temperature of a second energy application step further than the target/actual deviation defined within the temperature control.

In some embodiments, a transfer platform, a transfer platform surface, a construction platform and/or a construction platform surface is made at least in part from ceramic material such as silicon carbide or from ceramic material comprising at least silicon carbide, so as to be able to directly absorb the radiation or the energy of microwaves or of a device for generating microwave radiation at least in large quantities and to heat up quickly in this way. Preferably, such ceramic materials are rather thinner, for example, 0.2 mm to 2 mm or 0.5 mm to 5 mm, to form little thermal mass, to heat up quickly to very quickly in such a way and later (if necessary) to cool down again quickly. Preferably, such thinner versions of these microwave-absorbing ceramics are formed in thin plates, which preferably rest on thicker carrier plates or support plates or form a material bond with these or are firmly and/or non-detachably connected to one another in some other way. In some embodiments, microwave-absorbing ceramics can preferably be configured as plates or disks with material thicknesses of, for example, 1 mm to 4 mm, with or without special surface geometries, and can be used in this way as detachable surface elements, for example, resting on a (solid) transfer and/or construction platform made of a ceramic material such as aluminum oxide or aluminum nitride. In some embodiments, microwave absorbing ceramics are preferably applied as a surface coating, for example, pyrolytically, at least part of a transfer platform surface and/or construction platform surface and/or are applied at least on parts or within areas of a releasable surface element.

Preferably, instead of the treatment layer and the material layer, a layer can be applied by an extrusion process using an extruder as the application unit.

Further details, advantages and features of our devices and methods are shown in the following description of embodiments based on the drawings.

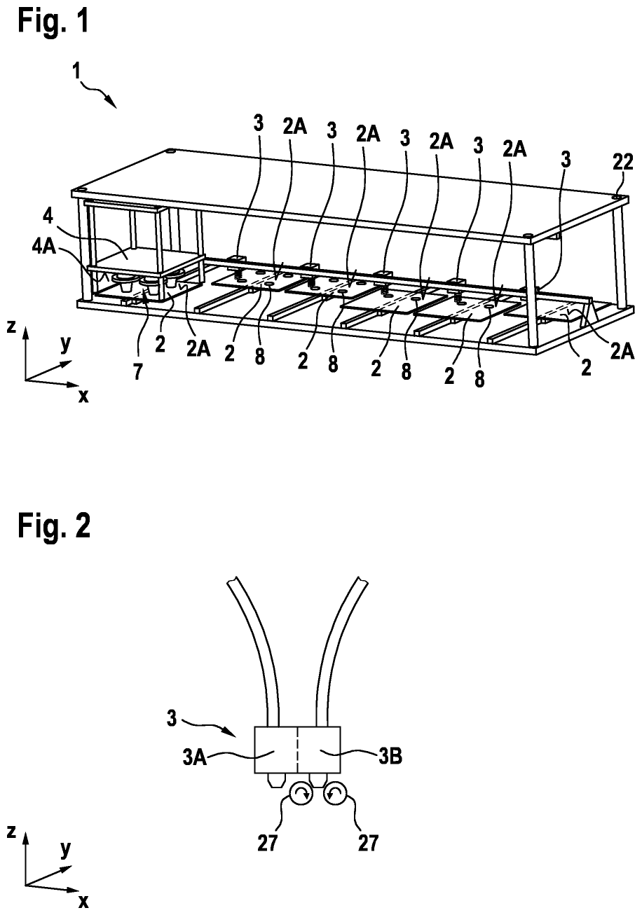

FIG. 1 schematically shows a manufacturing device 1 for the manufacture of an object 7 in layers. In the example shown, four similar objects 7 are manufactured simultaneously. For this purpose, there is a construction platform 4 with a construction platform surface 4A and six transfer platforms 2, each with a transfer platform surface 2A. An application unit 3 is assigned to each transfer platform 2. In this way, several layers 8 of the objects 7 can be manufactured essentially simultaneously (in parallel) (the production of the layers 8 is explained below). “Essentially simultaneous (parallel) production” means that the production of the multiple layers 8 using the transfer platforms 2 and the associated application units 3 overlaps at least partially in terms of time, preferably largely to completely overlaps in terms of time. This achieves parallelization in production. As soon as the individual layers 8 have been completed, these layers 8 are transferred to the construction platform 4. On the construction platform surface 4A, the layers 8 are thus assembled layer by layer to form the objects 7.

In this example, the manufacturing device 1 comprises two application units 3A, 3B for each transfer platform 2 (see FIG. 2). These application units 3A, 3B are in particular a printing unit 3A and a recoater 3B, which together apply the layers 8 using the so-called binder jetting process.

These application units 3A, 3B are shown in more detail in FIG. 2. In the following explanation, the application units 3A, 3B are collectively referred to as one application unit 3, which comprises the printing unit 3A and the recoater 3B.

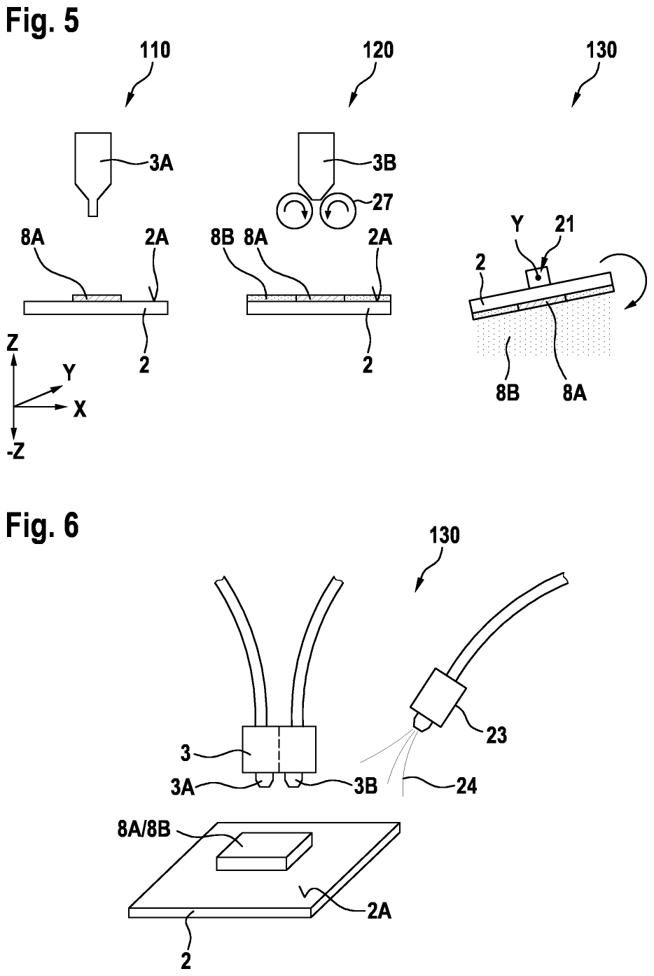

The application unit 3 comprises a printing unit 3A. The printing unit 3A is, for example, a piezo print head. In particular, the printing unit 3A is configured to apply a treatment layer (explained below with reference to FIG. 5) to the transfer platform 2. The treatment layer consists, for example, of a solvent. Furthermore, the application unit 3 comprises the recoater 3B. The recoater 3B contains rotatable rollers 27 and is configured to apply a granulate and/or powdery material to the transfer platform 2, and to form a material layer. According to the binder jetting process (explained in detail below), the layers 8 are formed by combining and bonding the treatment layer with the material layer.

In FIGS. 1 and 2, the printing units 3A and the recoaters 3B are shown as one-piece pairs. However, they can also be arranged spatially separated from each other in pairs. In particular, the printing unit 3A and the recoater 3B can be moved independently of each other.

Each application unit 3 may comprise one or more printing units 3A and/or one or more recoaters 3B. Furthermore, the manufacturing device 1 may comprise several of such application units 3 for each transfer platform 2.

With reference again to FIG. 1, the transfer platforms 2 according to the exemplary embodiment shown here are movable along the y-direction. Movement in a different spatial direction is preferably not provided. According to the exemplary embodiment shown here, the application units 3, in particular the printing units 3A and the recoaters 3B, move along the x-direction. This means that a contour/layer 8 can be created on each of the transfer platform surfaces 2A in the xy plane (the layer thickness in the z direction is neglected here). This allows layers 8 of any shape to be created on the transfer platform surfaces 2A. In some applications, one layer 8 may have a recess. If several layers 8 have a corresponding recess, a cavity can be formed within the object 7 to be manufactured by transferring these layers 8 to the construction platform 4 in series. Completely closed cavities can also be created without powder inclusions, as is the case with other known powder bed processes, such as selective laser melting (SLM).

Once the application of a layer 8 has been completed, the transfer platform 2 remains in a reference position, i.e. in a predefined position for transferring the layer 8 to the construction platform 4. In particular, all transfer platforms 2 can remain in the same reference position in the y-direction after the respective application of a layer 8. According to the exemplary embodiment shown here, the construction platform 4 preferably has a mobility in all three spatial directions, i.e. in the x-direction, in the y-direction and in the z-direction. This also means that the construction platform 4 can be moved in the opposite direction to the respective spatial directions, i.e. in the −x direction, in the −y direction and in the −z direction. This means that the construction platform 4 can be placed above the transfer platforms 2 to subsequently apply a pressing force in the −z direction to the transfer platforms 2. At the same time, the transfer platforms 2 are heated more than the construction platform 4. This results in the layers 8 being transferred from the transfer platforms 2. The layers 8 are applied either to the construction platform surface 4A itself or to object parts 9 of the objects 7 already present on the construction platform surface 4A. The object parts 9 are previously manufactured layers that have already been transferred to the construction platform 4 and joined together in the z-direction.

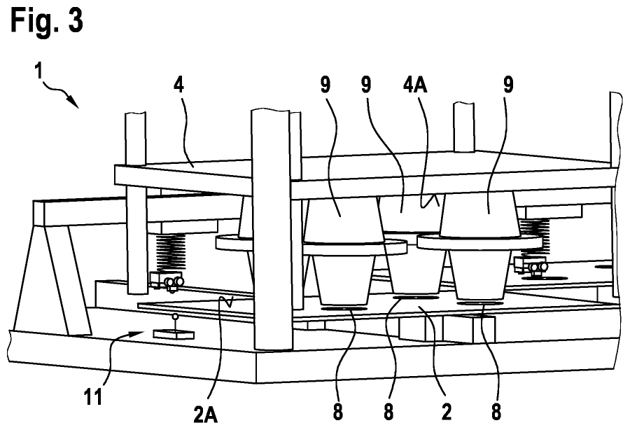

This is shown in more detail in FIG. 3.

Due to the possibility of pressing the individually manufactured layers 8, optimum strength of the objects 7 is achieved in the direction of the layer thickness, i.e. in the z-direction. In particular, notch effects are also avoided or reduced. Thus, in addition to faster production due to parallelization, the production quality is also increased.

The manufacturing device 1 preferably comprises a machining unit 11, in the exemplary embodiment shown in FIG. 3 in the form of a milling tool. The machining unit 11 enables the object parts 9 to be machined, especially before the objects 7 have been completed. This makes it possible to machine areas that are difficult or impossible to access once the respective object 7 has been completed. For machining, the construction platform 4 must be moved to the machining unit 11, wherein the machining unit 11 is preferably arranged in a stationary position. Alternatively or additionally, the machining unit 11 can be mounted so that it can be moved.

To design the production of the objects 7 efficiently, the adhesion of the layers 8 to the transfer platform surfaces 2A is lower than to the construction platform surface 4A or to the object parts 9 already present on the construction platform surface 4A. This is achieved in particular by a suitable material selection of the transfer platform surfaces 2 and the construction platform surface 4A or by corresponding coatings. The respective surface properties can also be different. Particularly advantageous, the transfer platforms 2 have surface structures for enlarging the transfer platform surfaces 2A. These surface structures can be fine ridges or pyramids, for example, wherein the surface structures are visible on the side of the layers 8 facing away from them. As a result, when the layers 8 are transferred to the construction platform 4, they are applied with a correspondingly enlarged surface to the layers 8 that were transferred to the construction platform 4 immediately beforehand, which increases the adhesion of the layers 8 to each other, i.e. of the newly manufactured layers 8 to the already existing object parts 9. Suitable temperature management can also be carried out at the moment of transfer of the finished layers 8. In particular, this temperature management can be carried out in addition to the heating steps (energy application steps) described below for producing the layers 8. In this way, an optimum, material-dependent temperature gradient can be set for the transfer by heating the transfer platforms 2 and/or the construction platform 4 accordingly. Targeted temperature control can also be achieved by additionally introducing thermal energy, for example, by ultrasound and/or thermal radiation (e.g. infrared radiation) and/or microwave radiation. Cooling, for example, by compressed air, can also be carried out in a targeted manner to achieve optimum transfer of the layers 8. Particularly advantageously, the temperature of the layers 8 during the transfer corresponds at least to the plasticizing temperature or the melting temperature of the material of the layers 8.

The method for manufacturing objects 7 in layers, including the manufacture of the layers 8 using the binder jetting process, is explained below.

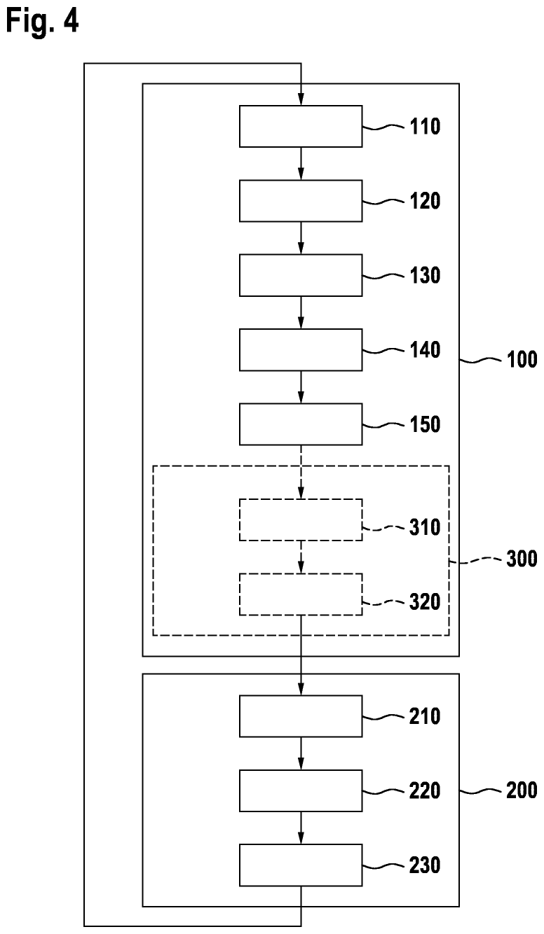

FIG. 4 shows a schematic overview of a manufacturing method that can preferably be carried out using the manufacturing device 1 described above. The method is initially divided into two steps, wherein in a first step at least one layer 8 is manufactured 100 on the transfer platform 2 and in a second step the layer(s) 8 are transferred 200 to the construction platform 4.

The step of producing 100 a layer 8 can preferably be carried out in parallel, i.e. this step is carried out several times and essentially simultaneously on different transfer platforms 2.

FIG. 5 shows detailed views of steps 110-130 of manufacturing 100 the layer 8.

First, at least one treatment layer 8A is applied to the transfer platform 2 by the application unit 3, in particular by the printing unit 3A of the application unit 3. The treatment layer 8A, which comprises a solvent, for example, is applied to the transfer platform 2, in particular to the transfer platform surface 2A, in accordance with a predeterminable pattern. The pattern according to which the treatment layer 8A is applied to the transfer platform surface 2A essentially corresponds to the shape of the layer 8 to be manufactured, which is transferred to the construction platform 4 to produce the object 7 (step 200).

At least one material layer 8B is then applied to the transfer platform surface 2A or to the transfer platform surface 2A and to the treatment layer 8A. The material layer 8B is formed from a granulate or powdery material. In particular, the material layer 8B is applied to the entire transfer platform surface 2A. The material layer 8B comes into contact with the treatment layer 8A at least in sections, wherein the material layer 8B is bonded to the transfer platform surface 2A at the points at which the treatment layer 8A is present on the transfer platform surface 2A.

The layer resulting from the combination of the treatment layer 8A with the material layer 8B is also referred to as the “pre-material layer”.

The order of application 110 of the treatment layer 8A and application 120 of the material layer 8B can be reversed. In other words, the material layer 8B can be applied first and then the treatment layer 8A. Preferably, the treatment layer 8A is still applied to the transfer platform 2 in accordance with the predeterminable pattern of the layer 8 to be manufactured.

After the application steps 110, 120, a cleaning step 130 takes place, in which the excess material of the material layer 8B is removed from the transfer platform 2. For this purpose, the manufacturing device 1 comprises, for example, a rotating device 21 which rotates the transfer platform 2 to remove the excess material of the material layer 8B. As shown in FIG. 5, the transfer platform 2 is rotated about an axis Y, which extends parallel to the y-direction (also referred to as the “second direction”).

Alternatively, the transfer platform 2 can also be rotated along an axis parallel to the x-direction or the z-direction to remove the excess material of the material layer 8B from the transfer platform 2. With the possible rotation around the axis parallel to the z-direction, a centrifugal force resulting from this rotation causes the excess material of the material layer to be removed from the transfer platform 2. However, the rotational speed of the transfer platform 2 is selected in such a way that the predetermined pattern of the pre-material layer is maintained. In particular, it is possible for the rotating device 21 to rotate the transfer platform 2 about an axis that extends in a plane defined by the x-direction and/or the y-direction and/or the z-direction.

The transfer platform 2 is preferably rotated by 180° about the axis Y, so that the transfer platform 2, as shown in FIG. 5, is oriented upside down after rotation, so that the transfer platform surface 2A points in the −z direction. After the excess material of the material layer 8B has fallen off the transfer platform surface 2A due to gravity, the transfer platform 2 is either rotated again by −180° or rotated by a further 180° (i.e. by a total of 360°) to return to the initial position (before rotation).

In an alternative embodiment of the manufacturing device 1, the application unit 3 can be arranged along the z-direction below the transfer platform 2. In this case, the transfer platform surface 2A points in the −z direction. In this embodiment, the cleaning step 130 can be omitted at least partially, in particular completely, since the excess material of the material layer 8B, which is not connected to the treatment layer 8A, falls down by gravity and does not remain on the transfer platform surface 2A.

The rotating device 21 can then rotate the transfer platform 2 by 180° so that the manufactured layer(s) 8 can be transferred 200 to the construction platform 4.

In a further, exemplary embodiment of the manufacturing method or the manufacturing device 1, the cleaning step 130 can be carried out by a cleaning device 23, as shown in FIG. 6.

In this case, the cleaning device 23 is configured to suck-in and/or blow-off a fluid 24, in particular air and/or inert gas. The cleaning device 23 is mounted, for example, on a frame 22 of the manufacturing device 1 shown in FIG. 1, in particular mounted in a movable manner. An outlet or inlet nozzle of the cleaning device 23 and/or the entire cleaning device 23 is preferably movably mounted. In a further exemplary embodiment, the cleaning device 23 is mounted in particular on the application unit 3 to be movable together with the latter.

The cleaning step 130 by the rotating device 21 can be combined with the cleaning step 130 by the cleaning device 23, in particular simultaneously or successively.

With reference again to FIG. 4, a first energy application step 140 is carried out after the application steps 110, 120. In principle, this can be carried out before or after the cleaning step 130. In this exemplary embodiment, the pre-material layer is heated by the energy application step 140. This energy application step is hereinafter referred to as “first heating step 140”.

In the first heating step 140, the pre-material layer comprising the treatment layer 8A and the material layer 8B is heated to a temperature close to the evaporation temperature of the treatment agent of the treatment layer 8A. “Close to the evaporation temperature” means a temperature range of about 20% around the evaporation temperature (i.e. above or below the evaporation temperature) of the treatment agent of the treatment layer 8A.

In one example, the treatment layer 8A comprises a deionized or fully desalinated water (demineralized water) as the treatment agent. The pre-material layer is thus heated in the first heating step 140 to approximately 80° C. to 120° C., in particular to 100° C.

This first heating step 140 largely removes the treatment layer 8A from the pre-material layer, so that essentially only the material layer 8B remains on the transfer platform 2.

The first heating step 140 can also be started during the application steps 110, 120. In particular, the transfer platform 2 can be preheated before the application 110 of the treatment layer 8A, wherein the vaporization temperature of the treatment agent of the treatment layer 8A is only reached after the application 120 of the material layer 8B and either before or after the cleaning step 130.

If the manufacturing device 1 is arranged in a closed room and/or in a closed container, the air pressure in the room/container can be reduced by the cleaning device 23 by sucking-in air to support or accelerate vaporization of the treatment layer 8A by the heating described above.

The manufacturing method also comprises a second energy application step 150. The second energy application step 150 is performed after the first heating step 140. The second energy application step 150 is hereinafter referred to as “second heating step 150”.

During the second heating step 150, the remaining material layer 8B is heated to a temperature close to or above the melting temperature of the material of the material layer 8B. “Close to the melting temperature” means a temperature range of about 20% around the melting temperature (i.e. above or below the melting temperature) of the material of the material layer 8B.

If, for example, high-performance polymers such as PEEK, PEI or PPSII are used as material for the material layer 8B, the material layer 8B can be heated to a temperature of approximately 250° C. to 350° C. If, as an alternative or in addition to the above-mentioned polymers, metals such as stainless steel are used as material for the material layer 8B, the material layer 8B can be heated to a temperature of about 1500° C. or more.

As can be seen from the dashed connecting lines in FIG. 4, the manufacturing method comprises selective steps 310, 320, which can be carried out before the transfer 200 of the layer 8 to the construction platform 4 according to an alternative embodiment of the manufacturing device or manufacturing method. If these steps 310, 320 are not carried out, the transfer 200 of the material layer 8B to the construction platform 4 takes place after the second heating step 150.

The remaining, preferably melted, material layer 8B heated in the second heating step 150 is preferably cooled after the second heating step 150. If the steps 310, 320 are not carried out, the material layer 8B then corresponds to the layer 8, which is then transferred to the construction platform 4.

In the following, the transfer 200 of the layer 8 to the construction platform 4 is first explained before the selective steps 310, 320 are explained.

The transfer step 200 comprises several sub-steps:

First, transfer platform 2 and construction platform 4 move relatively closer 210 (see FIGS. 1 and 3 in particular). The transfer platform 2 preferably remains immobile, while the construction platform 4 is moved along the x-direction, y-direction and z-direction.

The construction platform 4 is then pressed 220 onto the transfer platform 2 in the −z-direction. This ensures close contact and optimum adhesion of the layer 8 to the object parts 9, as described above.

Finally, the layer 8 is detached 230 from the transfer platform 2. The transfer platform 2 is then ready again to receive another pre-material layer, so that the steps of application 110, 120 can be carried out again. If several transfer platforms 2 are present, the layers 8 are transferred from the individual transfer platforms 2 to the construction platform 4 in a predeterminable sequence.

In the step of transferring 200, the construction platform 4 and the transfer platform 2 can be arranged centered relative to one another, in particular-viewed in plan view-completely overlapping, wherein a positioning of the layers 8 on the object parts 9 is predetermined in the steps of applying 110, 120, in particular in the step of applying 110 the treatment layer 8A. Alternatively or additionally, the layers 8 may be manufactured centered on the transfer platform 2 during application 110, 120, wherein positioning of the layers 8 on the object parts 9 is accomplished by relative orientation of the construction platform 4 and the transfer platform 2.

During the transfer step 200, the transfer platform(s) 2 and/or the construction platform 4 can be heated in addition to the heating steps 140, 150 explained above to transfer the layers 8 to the construction platform 4 with as little residue as possible. It is particularly advantageous if the construction platform 4 or the object parts 9 of the object 7 already present on the construction platform surface 4A are heated to a temperature close to, in particular below, the melting temperature of the material of the material layer 8B. For example, the temperature reached during this heating can be about 5%, preferably 10%, more preferably 15% below the melting temperature of the material of the material layer 8B.

Although the transfer 200 of the layer 8 resulting from the pre-material layer after the second heating step 150 has been described above, the transfer 200 can also be carried out before the first heating step 140 and/or before the second heating step 150. In such a case, after the transfer 200, the first heating step 140 and/or the second heating step 150 is carried out on the pre-material layer that has just been transferred to the building panel 4 and/or the object parts 9.

The aforementioned steps of manufacturing 100 and transferring 200 the layer(s) 8 can be repeated as often as desired until the object 7 is completed.

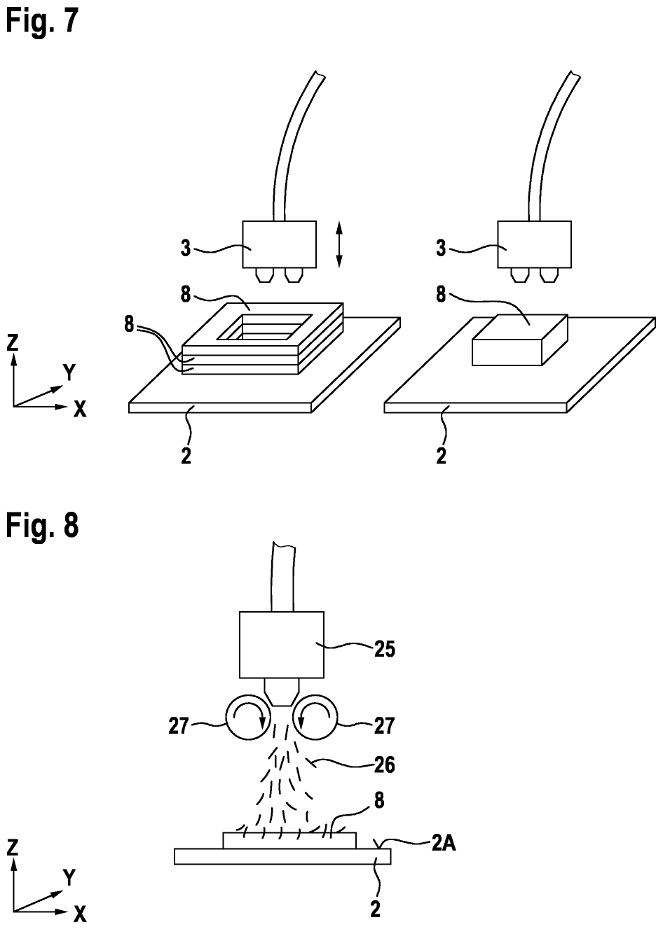

FIG. 7 shows a schematic detailed view of an embodiment of the manufacturing device 1. In particular, FIG. 7 shows a schematic representation of two transfer platforms 2 of the manufacturing device 1.

For example, three first layers 8, in particular pre-material layers, are manufactured on top of each other on a first transfer platform 2 (left), while a second layer 8 is manufactured on the second transfer platform 2 (right), the layer thickness/height of which in the z-direction essentially corresponds to the total height (in the z-direction) of the three first layers. The stacked layers 8 shown on the left in FIG. 7 can be pre-material layers that at least partially (still) include the treatment layer, or only include the material layer. For this purpose, the application unit 3 can be moved along the z-direction. Alternatively or additionally, the transfer platform 2 can also be moved along the z-direction. In this way, one or more levels of the object parts 9 can also be formed from a combination of individual or multiple layers 8 of multiple transfer platforms 2 after the layers 8 have been transferred to the construction platform 4.

The height or total height of these different layers 8 does not have to be the same. Instead, they can also be specifically formed in or with different heights, which in particular increases the strength of the object 7 in the z-direction at any predetermined points.

As explained above, different materials of the layers 8 can also be combined here to achieve a multi-material arrangement within a plane, which is formed from different layers 8 of several transfer platforms 2, of the finished object 7. Specifically, the three first layers 8 (FIG. 7, left) can advantageously be formed from different materials and the second layer 8 (FIG. 7, right) from a single material.

In the manufacture 100 of multiple layers 8, as shown in FIG. 7, steps 110-150 are preferably performed for each layer 8 before another layer 8 is manufactured. During the second heating step 150, the layers 8 can be fused together.

To adjust or move the application unit 3 and/or the transfer platform 2, the manufacturing device 1 can have a solid-state joint and/or a short-stroke cylinder and/or a motor, in particular a model-making servomotor. These can move and position the application unit 3 and/or the transfer platform 2 particularly preferably between predetermined end stops.

With reference to FIGS. 4 and 8, the selective steps 310, 320 are now explained, which are collectively referred to as fiber reinforcement 300.

FIG. 8 shows a schematic detailed view of an embodiment of the manufacturing device 1.

The manufacturing device 1 comprises at least one fiber application device 25. The manufacturing device 1 may comprise one fiber application device 25 for each transfer platform 2 and, in particular, an additional fiber application device 25 for the construction platform 4. In the example shown in FIG. 1, the manufacturing device 1 would thus comprise seven fiber application devices 25 (six for the six transfer platforms 2 and one for the construction platform 4). Similar to the recoater 3B, the fiber application device 25 comprises rotatable rollers 27 by which the fiber application device 25 can apply the transfer platform 2, in particular the layer 8, with fibers 26 in a fiber application step 310.

The fibers 26 are preferably carbon fibers. The fibers 26 preferably have a length of up to a few millimeters (so-called “short fibers”). Alternatively, the short fibers can preferably have a length of less than 1 mm. In this case, fibers of different lengths can also be combined with one another.

The fibers 26 are accelerated in the direction (−z direction) of the transfer platform 2 by the rotating rollers 27. Due to their air resistance, the fibers 26 can largely orient or align themselves in such a way that they hit the layer 8 at a steep angle (45° to 90° relative to the layer 8 or to the x-direction). The fibers 26, which hit layer 8 at a steep angle, penetrate layer 8. They can penetrate completely into layer 8 or only partially into layer 8.

The fibers 26 that do not hit layer 8 at a steep angle, i.e. at a flat angle of 0° to 45° relative to layer 8, penetrate little or not at all into layer 8. Most of them remain on the surface of layer 8. These fibers 26 can then be removed from the layer 8, for example, by the cleaning device 23 or by rotation by the rotating device 21. Alternatively or additionally, these fibers 26 can be detached from the surface of the layer 8 by ultrasound.

Alternatively or in addition to the rotating rollers 27, the fibers 26 can be accelerated by a material flow, for example, a gas flow of air and/or inert gas (not shown). By using such a material flow, the orientation of the fibers 26 can advantageously be influenced, in particular on average, to a steep angle of approximately 90°.

The fiber application device 25 can also apply fibers 26 to the object parts 9 on the construction platform 4. When the object parts 9 are connected to the layer 8, which has also been applied with fibers 26, the fibers 26 of the object parts 9 can penetrate into the layer 8 and vice versa. For this purpose, the object parts 9 and/or the layer 8 can advantageously be heated and/or exposed to solvent and/or excited by ultrasound to reduce the surface tension of the object parts 9 and/or the layer 8. In a further, third energy application step 320, the pre-material layer comprising the treatment layer 8A and the material layer 8B or only the material layer 8B (after the first heating step 140) is heated before and/or during the application 310. The third energy application step 320 is hereinafter referred to as “third heating step 320”.

The third heating step 320 reduces the surface tension of the material layer 8B so that the fibers 26 can penetrate deeper into it.

After the third heating step 320, the material layer 8B is cooled (not shown).

Alternatively or in addition to the third heating step 320, the surface tension of the material layer 8B can be reduced by a solvent which is applied, for example, by the cleaning device 23 and/or the printing unit 3A.

In particular, the fiber reinforcement 300 described above is performed after the cleaning step 130. Preferably, the fiber reinforcement is performed after the first heating step 140 and during the second heating step 150. Alternatively or additionally, the fiber reinforcement 300 may be performed after the second heating step 150, wherein, in particular in the third heating step 320, the temperature of the material layer 8B is maintained close to the melting temperature of the material of the material layer 8B so that the fibers 26 can penetrate therein.

If the selective steps 310, 320 of the fiber reinforcement 300 are performed, the resulting fiber-reinforced material layer 8B is referred to as the layer 8 to be transferred. After the fiber reinforcement 300, the previously described transfer 200 of the (fiber-reinforced) layer 8 to the construction platform 4, in particular to the object parts 9, then takes place.

If the selective steps 310, 320 of the fiber reinforcement 300 are carried out, the application units 3 may in particular be extruders which do not produce the layer(s) 8 using the binder jetting process. The extruders can output the same material or different materials can be provided, so that different materials can be applied to different transfer platforms 2. These extruders work particularly advantageously according to the FFF process.

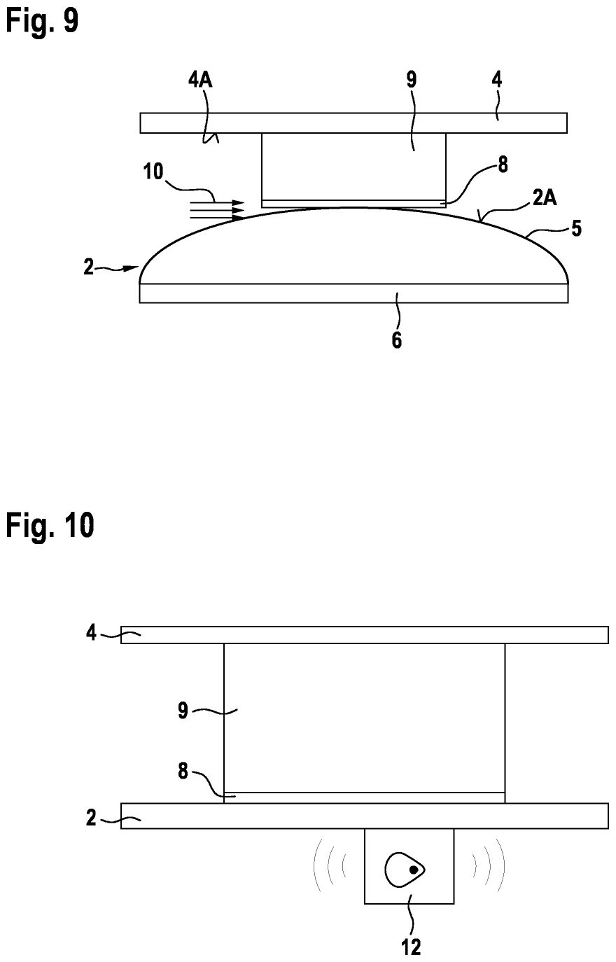

FIG. 9 shows a further embodiment of the manufacturing device 1. Each transfer platform 2 is formed by a holding plate 6 and a foil element 5. The foil element 5 in turn forms the transfer platform surface 2A. Thus, the layer 8 is applied to the foil element 5 by the application unit 3 (and is therefore not in direct contact with the holding plate 6). The foil element 5 is in contact with the holding plate 6, so that the transfer platform surface 2A acts like a plate surface (not shown in FIG. 9). The holding plate 6 can be heated. To enable the foil element 5 to fit properly against the holding plate 6, a clamping device for the foil element 5 is preferably provided (not shown). Additionally or alternatively, it is also possible that the space enclosed by foil element 6 and holding plate 5 can be subjected to a negative pressure to enable the foil element 5 to fit tightly against the holding plate 6. The foil element 5 may be elastic.

After the layer 8 has been manufactured on the foil element 5 as explained above, the layer 8 is transferred to the construction platform 4, in FIG. 9, for example, to an object part 9 that has already been manufactured. To detach the layer 8 from the foil element 5, the foil element 5 is lifted from the holding plate 6 in certain areas so that the layer 8 is peeled off from its edges. This lifting of the foil element 5 can be achieved, for example, by a controllable supply of a fluid working medium into the space enclosed by the foil element 6 and the holding plate 5. The detachment process can be carried out by supplying compressed air 10 to one of the edges of the layer 8, wherein the compressed air 10 also provides a cooling effect.

The use of the foil element 5 thus enables simple and reliable transfer of the layer 8, wherein damage to the layer 8 or the object part 9 is prevented. The foil element 5 is preferably made of polyimide.

FIG. 10 shows a schematic detailed view of a further embodiment of the manufacturing device 1.

The manufacturing device 1 comprises at least one vibration generating device 12. The vibration generating device 12 can comprise an ultrasonic probe, a sound wave generator and/or a mechanical vibration generator such as an eccentric imbalance. In particular, the manufacturing device 1 comprises a vibration generating device 12 for each transfer platform 2. Alternatively, a single vibration generating device 12 can be arranged in the manufacturing device 1 in such a way that it applies vibrations to all transfer platforms 2 and/or the construction platform 4 in the operating state.

The vibration generating device 12 can be used to introduce vibrations into the manufacturing device 1 (here in particular into the transfer platform 2), for example, to increase the layer strengths during the transfer of the layers 8 from the transfer platform 2 to the construction platform 4 by a targeted introduction of energy, in particular thermal energy and/or kinetic energy, at the contact surfaces. Kinetic energy can support the bonding of polymer chains in or between the layers 8.

The vibration generating device 12 may further be used to remove the excess material of the material layer 8B during the cleaning step 130, or to assist removal of the excess material by, for example, the rotating device 21 and/or by the cleaning device 23.

The manufacturing device 1 can have at least one further vibration generating device 12 for the construction platform 4.

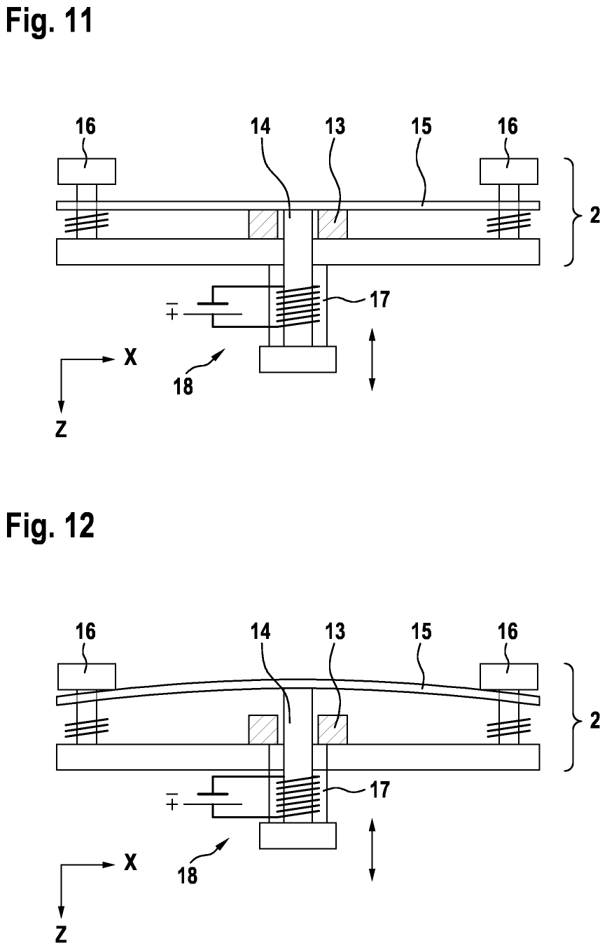

FIGS. 11 and 12 show schematic detailed views of a further embodiment of the manufacturing device 1. FIGS. 11 and 12 show in particular an embodiment of the transfer platform 2 of the manufacturing device 1, with FIG. 11 showing a basic state of the transfer platform 2 and FIG. 12 showing a curved state of the transfer platform 2, as will be explained below.

The transfer platform 2 comprises a transfer plate 15, wherein the layers 8 are manufactured on the transfer plate 15 as explained above. The transfer platform 2 also comprises an active actuator 17, which can selectively bend the transfer plate 15. The transfer platform 2 also comprises spacers 13, which control the height of the transfer plate 15 during pressing.

Such a spacer 13 can in particular be made of a hard material or elastic material.

In addition, the transfer platform comprises two adjusting screws 16, which serve as counter bearings for the curvature. Depending on the arrangement of the adjusting screws 16, the transfer plate 15 is curved evenly or almost evenly in the x-direction and y-direction. If the adjusting screws 16 are arranged differently and/or the transfer plate 15 is stiffened on two opposite sides, for example, by a strut (not shown), the transfer plate 15 can be bent at least predominantly in only one direction. The adjusting screws 16 can also be used to adjust the parallelism of the transfer plate 15 to the plane of the application unit 3. In particular, the adjusting screws 16 can be driven electrically.

The actuator 17 is preferably moved by an electromagnet 18, as shown in FIGS. 11 and 12. Alternatively, the actuator 17 can also be a pneumatic cylinder. The actuator 17 is connected to a tappet 14, which transmits forces generated by the electromagnet 18 to the transfer plate 15.

The transfer plate 15 is preferably configured as a CFRP (carbon fiber reinforced plastic) or GFRP (glass fiber reinforced plastic) plate.

Such an active curvature of the transfer plate 15 can be used when transferring the layer 8 from the transfer platform 2 to the construction platform 4. This can take place in particular at the moment at which the actual pressing process is started. As a result, force can be transferred over a certain distance, which is defined by a radius of curvature. In this way, the surface forces or the effective pressure can be increased without having to significantly increase the total force, as initially only areas near the center of curvature are applied.

It is also advantageous that any air or protective gases present, particularly in the area of the center of the curvature, especially in the case of relatively large-area structures or layers 8, can escape to the outside more easily.

Preferably, the electromagnet 18 can be switched in pulsed mode, wherein dynamic oscillations can be generated by pulsating curvatures in the transfer plate 15.

In addition, the curvature allows the layers 8 to be detached more easily from the transfer plate 15, in particular after the aforementioned cooling after the second or third heating step 150, 320, and transferred to the construction platform 4. In particular, this can reduce tensile forces acting on the layers 8 during detachment of the layers 8.

This advantageous configuration can be combined in particular with the foil element 5 described above.

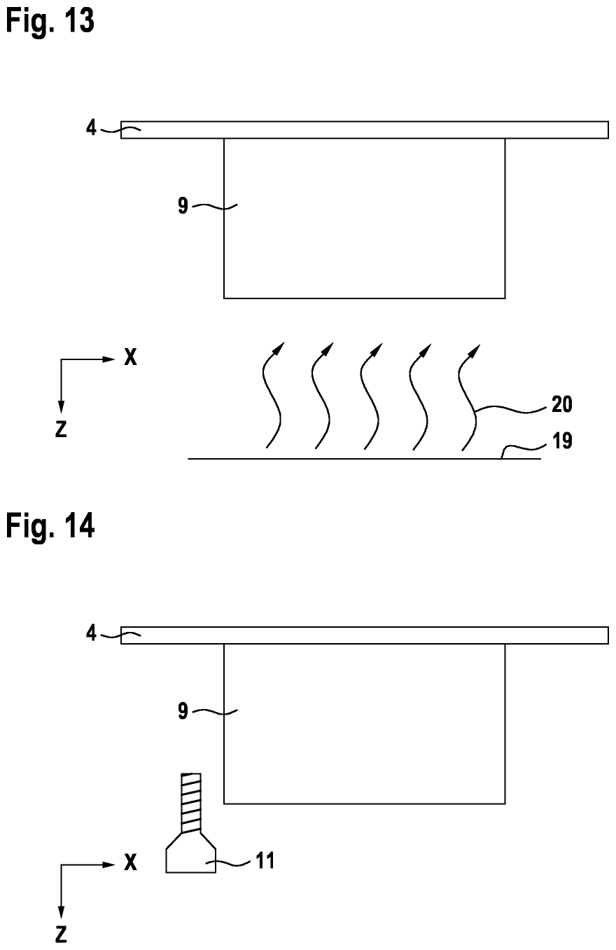

FIG. 13 shows a schematic detailed view of a further embodiment of the manufacturing device 1. The manufacturing device 1 comprises a heating device 19, preferably a heat radiator 19, particularly preferably an infrared light source 19, which applies heat/heat radiation 20 to object parts 9. The heating device 19 can thus, as shown in FIG. 13, in particular temporarily and quickly heat the layers 8 of the object parts 9 last transferred to the construction platform 4, so that more thermal energy is available for bonding the layer 8 currently to be transferred to the object part 9 during the transfer 200. The heating device 19 can in particular also be used for the heating steps 140, 150 and/or 320 explained above.

Alternatively or in addition to the radiant heater 19, the layers 8 can also be heated inductively by an electric field generated by a generator (not shown) as a heating device 19.

FIG. 14 shows a schematic detailed view of a further embodiment of the manufacturing device 1. In particular, a detailed view of the machining unit 11 is shown.

As explained above, the machining unit 11 is configured in particular as a milling tool 11. The machining unit 11 can machine the object parts 9 after each transfer of a layer 8 and/or after the transfer of several layers 8 to achieve a higher dimensional accuracy and a better surface quality. A lower flat surface of the object parts 9 can also be machined in this way, so that optimum flatness of the object parts 9 or the finished object 7 can be achieved.

In particular, this prevents flatness errors from occurring in the transferred layers 8, which could otherwise accumulate or propagate in the object parts 9. This can increase the quality of the object 7.

The machining unit 11 may machine fibers 26 protruding from the object parts 9 in particular.

Furthermore, the manufacturing device 1 may comprise a system for monitoring the flatness (not shown). For this purpose, the manufacturing device 1 can have a tactile or non-contact system such as a laser measuring system or other optical systems.

Using such measurements, which can also monitor the entire height of the object part 9, it is also advantageously possible to actively control the quantities of material used in the printing process on the transfer platforms 2. Furthermore, it is possible to regulate the orientation of the transfer platforms 2 via the adjusting screws 16, which are driven electrically in particular, so that the layer height can be varied slightly locally in a targeted manner, thus reacting to possible warpage and allowing the component to continue to be built up planar. This control can use the detected flatness and/or height of the object part 9 to regulate the material flow, in particular the amount of material that the application units 3 transfer to the transfer platforms 2. For this purpose, the manufacturing device 1 can comprise a control unit or a regulation unit, in particular in the form of a CPU (not shown). In particular, this can carry out or control/regulate the method steps described above for manufacturing an object using the manufacturing device 1.

The above-described embodiments of the manufacturing device 1 can be suitably combined with one another. As one example of several possibilities for this, the manufacturing device 1 may comprise the machining unit 11 and the heating device 19.

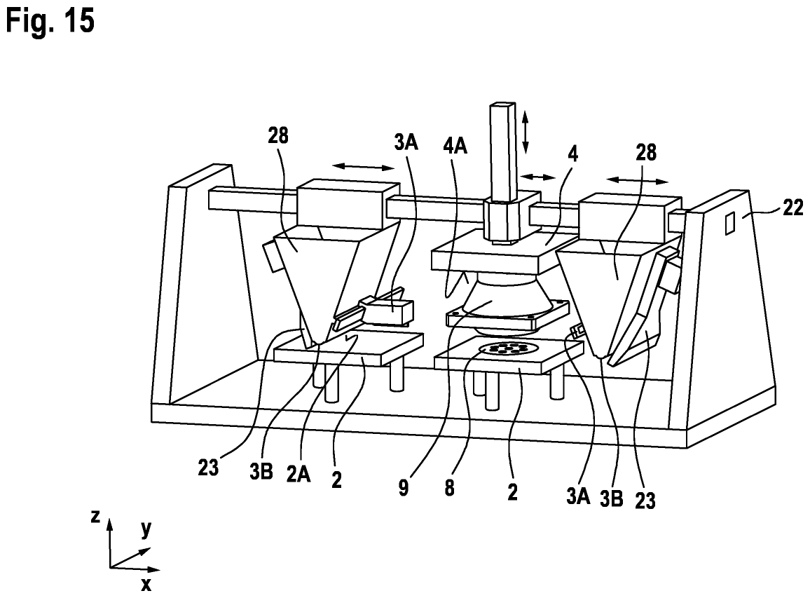

FIG. 15 shows a schematic illustration of a manufacturing device 1 according to an embodiment.

In this embodiment, the manufacturing device 1 comprises two transfer platforms 2 and a construction platform 4.

The manufacturing device 1 comprises printing units 3A configured as piezo print heads. Furthermore, the manufacturing device 1 comprises storage containers 28 for the material of the material layer. Openings and rollers are arranged at a lower end (in the Z direction) of the storage containers 28, which together act as a recoater 3B for applying the material and forming the material layer.

Furthermore, the manufacturing device 1 comprises two cleaning devices 23.

In this embodiment, the cleaning devices 23 are configured to suck up excess material. The cleaning devices 23 are each connected to one of the storage containers 28 and return the sucked-off material, which is not connected to the treatment layer and is therefore surplus, to the storage container 28.

In the manufacturing device 1 according to this embodiment, a storage container 28 together with a recoater 3B, a printing unit 3A and a cleaning device 23 are formed together as a module which is movable along the X-direction. The printing unit 3A can also be moved along the Y-direction.

FIG. 15 shows a point in time immediately before the transfer of the pre-material layer 8. The pre-material layer 8 was previously applied and cleaned by the module on the right in the X direction (removal of excess material). The right-hand module was then moved to the right-hand edge so that the construction platform 4 with the previously manufactured object parts 9 could be moved over the right-hand transfer platform 2. In the next step, the pre-material layer 8 is transferred to the object parts 9 by moving the construction platform 4 in the Z direction. After or during this, the left-hand module produces the next pre-material layer 8. In this way, several pre-material layers 8 can be manufactured as seamlessly as possible on the transfer platforms 2 and transferred one after the other to the construction platform or the object parts 9.

In addition to the above written description, explicit reference is hereby made to the graphic representation in FIGS. 1 to 15 for its supplementary disclosure.

Disclosed herein is:

(1) A manufacturing device for manufacturing objects in layers, including at least one transfer platform with a transfer platform surface, at least one application unit which is configured for applying at least one treatment layer and at least one material layer, in particular including granular and/or powdery material, which together form a pre-material layer of the object, to the transfer platform surface, wherein the pre-material layer extends in particular in a first direction (x) and in a second direction (y), and a construction platform which is configured for receiving at least the material layer of the pre-material layer from the transfer platform so that the object is manufactured in layers on the construction platform in a third direction (z), in particular.
(2) The manufacturing device according to (1), characterized in that the construction platform includes a construction platform surface and is configured to receive at least the material layer of the pre-material layer from the transfer platform on the construction platform surface or on object parts of the object already present on the construction platform surface.
(3) The manufacturing device according to (2), characterized in that the construction platform surface is oriented substantially parallel to the transfer platform surface while receiving at least the material layer of the pre-material layer from the transfer platform.
(4) The manufacturing device according to any one of the preceding (1) to (3), including at least one rotating device which is configured to rotate the at least one transfer platform, in particular about an axis substantially parallel to the first direction (x) and/or about an axis (Y) substantially parallel to the second direction (y) and/or about an axis substantially parallel to the third direction (z).
(5) The manufacturing device according to any one of the preceding (1) to (4), including at least one cleaning device which is configured to remove excess material of the material layer from the at least one transfer platform and/or the construction platform by sucking-off and/or blowing-off a fluid.
(6) The manufacturing device according to any one of the preceding (1) to (5), including at least one vibration generating device which is configured to remove excess material of the material layer from the at least one transfer platform and/or the construction platform by sound and/or vibrations.
(7) The manufacturing device according to any one of the preceding (1) to (6), including at least one fiber application device which is configured to apply fibers at least partially on the pre-material layer, in particular the material layer of the pre-material layer, on the transfer platform and/or object parts of the object on the construction platform.
(8) The manufacturing device according to any one of the preceding (1) to (7), characterized by a plurality of transfer platforms, wherein preferably each transfer platform is assigned at least one distinct application unit.
(9) The manufacturing device according to any one of the preceding (1) to (8), including at least one energy application device which is configured to supply energy to the treatment layer and/or the material layer and/or the object parts of the object, wherein the energy application device is configured in particular for evaporating or vaporizing the treatment layer and/or for plasticizing the material layer and/or for melting the material layer of the pre-material layer of the object.
(10) A method of manufacturing objects in layers, including the steps of:
applying at least one treatment layer to at least one transfer platform by an application unit, wherein the treatment layer extends in particular in a first direction (x) and in a second direction (y),
applying at least one material layer, in particular including granular and/or powdery material, to the transfer platform before or after application of the treatment layer, wherein the treatment layer and the material layer form a pre-material layer of the object,
transferring at least the material layer of the pre-material layer from the transfer platform to a construction platform, in particular along a third direction (z), and
repeating the steps of applying the at least one treatment layer and the at least one material layer and of transferring, so that the object is manufactured on the construction platform in layers, in particular in the third direction (z).
(11) The method according to (10), characterized by a cleaning step after the application of the treatment layer and after the application of the material layer, in which excess material of the material layer is removed from the transfer platform.
(12) The method according to (10) or (11), characterized by a first energy application step before and/or during and/or after the application of the treatment layer and/or before and/or during and/or after the application of the material layer.
(13) The method according to any one of (10) to (12), characterized by a second energy application step, in particular after the first energy application step, in which the pre-material layer is heated to a temperature in particular lower than or equal to or higher than the melting temperature or the melting range of the material of the material layer.
(14) The method according to any one of (10) to (13), characterized by a fiber application step, in particular after the cleaning step, in which the pre-material layer is at least partially applied with fibers.
(15) The method according to (14), characterized by a third energy application step before and/or during the fiber application step, in which energy is supplied to the pre-material layer on the transfer platform and/or to the object parts of the object on the construction platform before and/or during the application with fibers.

What is claimed is:

1. A manufacturing device for manufacturing an object in layers, comprising
at least one transfer platform with a transfer platform surface,
at least one application unit configured to apply at least one treatment layer and at least one material layer, which together form a pre-material layer of the object, to the transfer platform surface, wherein the pre-material layer extends at least in a first direction (x) and/or in a second direction (y), and
a construction platform configured to receive at least the at least one material layer of the pre-material layer from the transfer platform so that the object is manufactured in layers on the construction platform in a third direction (z).

2. The manufacturing device according to claim 1, wherein the construction platform comprises a construction platform surface and is configured to receive at least the at least one material layer of the pre-material layer from the transfer platform on the construction platform surface or on object parts of the object already present on the construction platform surface.

3. The manufacturing device according to claim 2, wherein the construction platform surface is oriented substantially parallel to the transfer platform surface while receiving at least the at least one material layer of the pre-material layer from the transfer platform.

4. The manufacturing device according to claim 1, comprising at least one rotating device configured to rotate the at least one transfer platform, about an axis substantially parallel to the first direction (x) and/or about an axis (Y) substantially parallel to the second direction (y) and/or about an axis substantially parallel to the third direction (z).

5. The manufacturing device according to claim 1, comprising at least one cleaning device configured to remove excess material of the at least one material layer from the at least one transfer platform and/or the construction platform by sucking-off and/or blowing-off a fluid.

6. The manufacturing device according to claim 1, comprising at least one vibration generating device configured to remove excess material of the at least one material layer from the at least one transfer platform and/or the construction platform by sound and/or vibrations.

7. The manufacturing device according to claim 1, comprising at least one fiber application device configured to apply fibers at least partially on the pre-material layer, or the at least one material layer of the pre-material layer, on the transfer platform and/or object parts the object on the construction platform.

8. The manufacturing device according to claim 1, further comprising a plurality of transfer platforms.

9. The manufacturing device according to claim 1, comprising at least one energy application device configured to supply energy to the treatment layer and/or the at least one material layer and/or the object parts of the object, wherein the energy application device is configured to evaporate or vaporize the treatment layer and/or to plasticize the material layer and/or to melt the at least one material layer of the pre-material layer of the object.

10. A method of manufacturing an object in layers, comprising the steps of:
applying at least one treatment layer to at least one transfer platform by an application unit, wherein the treatment layer extends at least in a first direction (x) and/or in a second direction (y),
applying at least one material layer to the transfer platform before or after application of the treatment layer, wherein the treatment layer and the material layer form a pre-material layer of the object,
transferring at least the material layer of the pre-material layer from the transfer platform to a construction platform, along a third direction (z), and
repeating the steps of applying the at least one treatment layer and the at least one material layer and of transferring, so that the object is manufactured on the construction platform in layers, in the third direction (z).

11. The method according to claim 10, further comprising a cleaning step after the application of the treatment layer and after the application of the material layer, in which excess material of the material layer is removed from the transfer platform.

12. The method according to claim 10, further comprising a first energy application step before and/or during and/or after the application of the treatment layer and/or before and/or during and/or after the application of the material layer.

13. The method according to claim 10, further comprising a second energy application step, in which the pre-material layer is heated to a temperature lower than or equal to or higher than the melting temperature or the melting range of the material of the material layer.

14. The method according to claim 10, further comprising a fiber application step in which the pre-material layer is at least partially applied with fibers.

15. The method according to claim 14, further comprising a third energy application step before and/or during the fiber application step, in which energy is supplied to the pre-material layer on the transfer platform and/or to the object parts of the object on the construction platform before and/or during the application with fibers.
